(19) United States
(12) Patent Application Publication
(10) Pub. No.: US 2011/0057911 A1
(43) Pub. Date: Mar. 10, 2011

(54) PLASMA DISPLAY PANEL DRIVING METHOD AND PLASMA DISPLAY APPARATUS

(76) Inventors: Hiroyasu Makino, Osaka (JP); Toshikazu Wakabayashi, Osaka (JP); Satoshi Kominami, Osaka (JP); Yasuhiro Arai, Osaka (JP); Masumi Izuchi, Osaka (JP); Junko Matsushita, Osaka (JP); Hideki Nakata, Osaka (JP)

(21) Appl. No.: 12/991,828

(22) PCT Filed: May 14, 2009
(86) PCT No.: PCT/JP2009/002100

§ 371 Date: Nov. 9, 2010

(30) Foreign Application Priority Data
May 16, 2008 (JP) 2008-129383

(51) Int. Cl. G06F 3/038; G09G 3/28

(52) U.S. Cl. 345/208; 345/60

(57) ABSTRACT

A plurality of display electrode pairs are divided into two display electrode pair groups I and II. One field is divided into M (M is an integer of 2 or more) sub-fields SFL (L=1 to M) each including a wall voltage adjusting period, an address period, and a sustain period. Based on a sustain period T1 of a K-th sub-field SFK and a wall voltage adjusting period T2 positioned between the sustain period T1 and the address period of a (K+1)-th sub-field, if T1>T2, a first driving method in which the sustain period T1 and the wall voltage adjusting period T2 are set for each of the display electrode pair groups I and II is used in the sub-field SFK, and if T1<T2, a second driving method in which the sustain periods T1 are set so as to be synchronized with each other and the wall voltage adjusting periods T2 are set so as to be synchronized with each other among the display electrode pair groups I and II is used in the sub-field SFK.

### TECHNICAL FIELD

The present invention relates to a plasma display panel driving method and a plasma display apparatus that is a display apparatus using a plasma display panel.

### BACKGROUND ART

A typical display apparatus using a plasma display panel (hereinafter referred to as “PDP”) is currently an AC surface discharge type plasma display apparatus. In the AC surface discharge type PDP, a large number of discharge cells are formed by providing a front substrate and a rear substrate to be opposed to each other. Hereinafter, the configuration of the AC surface discharge type PDP will be explained.

On the front substrate, a plurality of display electrode pairs each including a scan electrode and a sustain electrode are formed to extend in parallel with one another in a row direction. In addition, on the front substrate, a dielectric layer and a protective layer are stacked and formed to cover the display electrode pairs.

On the rear substrate, a plurality of data electrodes are formed to extend in parallel with one another in a column direction. In addition, on the rear substrate, a dielectric layer is formed to cover the data electrodes, and a grid-like dividing wall is further formed on the dielectric layer. In a space defined by an upper surface of the dielectric layer and a side surface of the dividing wall, a phosphor layer which emits light of red, green, or blue is formed.

The front substrate and rear substrate formed as above sandwich a minute discharge space and are provided to be opposed to each other such that the display electrode pairs and the data electrodes three-dimensionally cross one another, and outer peripheral portions of the front substrate and the rear substrate are sealed by a sealing material. A discharge gas is filled in the discharge space. Thus, the discharge cells are formed at portions where the display electrode pairs and the data electrodes intersect with one another. In each discharge cell, ultraviolet is generated by gas discharge and excites each phosphor, thereby carrying out color display.

Used as a method for driving the PDP is a sub-field method that is a method for dividing one field period into a plurality of sub-fields whose luminance weights are determined; and carrying out a gray scale display by combinations of the sub-fields in each of which light is emitted. Each sub-field includes a reset period, an address period, and a sustain period.

In the reset period, a predetermined voltage is applied to the scan electrodes and sustain electrodes of the display electrode pairs to cause reset discharge, and wall charge necessary for a next address operation is generated on each electrode. In the address period, a scan pulse is sequentially applied to the scan electrodes, and an address pulse is selectively applied to the data electrodes of the discharge cells in accordance with a display image to cause address discharge, thereby generating the wall charge on each electrode. In the sustain period, a sustain pulse is alternately applied to the display electrode pairs each including the scan electrode and the sustain electrode to cause sustain discharge for a time corresponding to the luminance weight, and the phosphor layers of the corresponding discharge cells emit light to carry out image display.

Among the sub-field methods, generally used is an ADS (Address and Display Separation) method in which the address period and the sustain period are completely separated from each other in terms of time. In the ADS method, since there is no timing shared by the discharge cell in which the address discharge is caused and the discharge cell in which the sustain discharge is caused, the PDP can be driven under conditions most appropriate for the address discharge in the address period and conditions most appropriate for the sustain discharge in the sustain period. Therefore, discharge control is comparatively easy, and a drive margin of the PDP can be set to be large.

However, in the ADS method, the sustain period is set in a period other than the address period. Therefore, if a time required for the address period becomes long due to, for example, an increase in definition of the PDP, an adequate number of sustain pulses or sub-fields for securing an image quality cannot be secured. For example, in order to drive an ultra high definition PDP including 2,160 lines or 4,320 lines, in the ADS method, if the number of sustain pulses or sub-fields is not reduced, the time required for the address period exceeds a time of one field.

Here, disclosed is a driving method in which the display electrode pairs are divided into a plurality of blocks, and start times of the sub-fields of respective blocks are set to be different from one another such that the address periods of two or more blocks among the plurality of blocks do not overlap each other in terms of time (see PTL 1, for example).

### CITATION LIST

### Patent Literature

PTL 1: Japanese Laid-Open Patent Application Publication No. 2005-157338

### SUMMARY OF INVENTION

### Technical Problem

However, in the driving method disclosed in PTL 1, a drive time depends on various conditions, such as the number of blocks, the number of scan electrodes, the number of sub-fields, the number of sustain pulses, and a time required for the address discharge and the sustain discharge. Therefore, if the number of sustain pulses or sub-fields is not reduced, the drive time may exceed the time of one field, and the adequate number of sustain pulses or sub-fields may not be secured.

Moreover, a further increase in definition of the PDP has been pursued, and a method for driving an ultra high definition panel including 2,160 lines, 4,320 lines, or the like has been desired. However, the time required for the address period tends to further increase in accordance with the increase in definition. In the driving method disclosed in PTL 1, in order that the address periods of two or more blocks do not overlap each other in terms of time, the drive time exceeds the time of one field as with the above case, and it is difficult to adequately secure the number of sub-fields while securing adequate luminance.

The present invention was made in light of the above problems, and an object of the present invention is to provide a PDP driving method and a plasma display apparatus, in each of which even in the case of an ultra-large ultra-high-definition PDP, the sub-fields, the number of which is necessary for securing adequate image quality, can be set in one field, and adequate luminance can be secured.

### Solution to Problem

In order to solve the above problems, a plasma display panel driving method according to the present invention is a method for driving a plasma display panel including: a first substrate on which a plurality of display electrode pairs are arranged side by side, each of the plurality of display electrode pairs being constituted by a scan electrode and a sustain electrode; and a second substrate which is provided to be opposed to the first substrate and on which a plurality of data electrodes are arranged so as to three-dimensionally cross the plurality of display electrode pairs, discharge cells being configured at respective positions where the plurality of display electrode pairs and the plurality of data electrodes three-dimensionally cross one another, the method including the steps of: dividing the plurality of display electrode pairs into N (N is an integer of 2 or more) display electrode pair groups; dividing one field into M (M is an integer of 2 or more) sub-fields SFL (L=1 to M), each of the sub-fields including a wall voltage adjusting period in which a wall voltage of the discharge cell is adjusted for address discharge of the discharge cell, an address period in which the address discharge of the discharge cell selected in accordance with an image signal is carried out, and a sustain period in which sustain discharge of the discharge cell in which the address discharge has been carried out is carried out; and in a case where the sustain period of a K-th sub-field SFK is defined as T1 and the wall voltage adjusting period positioned between the sustain period T1 and the address period of a (K+1)-th sub-field is defined as T2, if T1>(N×1)×T2, using a first driving method in the sub-field SFK, the first driving method being a method for setting the sustain period and the wall voltage adjusting period in the sub-field SFK for each of the N display electrode pair groups, and if T1<(N−1)×T2, using a second driving method in the sub-field SFK, the second driving method being a method for setting the sustain periods and the wall voltage adjusting periods in the sub-field SFK such that the sustain periods are synchronized with one another and the wall voltage adjusting periods are synchronized with one another among the N display electrode pair groups.

Moreover, in order to solve the above problems, a plasma display apparatus according to the present invention includes: a plasma display panel including a first substrate on which a plurality of display electrode pairs are arranged side by side, each of the plurality of display electrode pairs being constituted by a scan electrode and a sustain electrode, and a second substrate which is provided to be opposed to the first substrate and on which a plurality of data electrodes are arranged so as to three-dimensionally cross the plurality of display electrode pairs, discharge cells being configured at respective positions where the plurality of display electrode pairs and the plurality of data electrodes three-dimensionally cross one another; N scan electrode driving circuits configured to respectively drive the scan electrodes of N display electrode pair groups obtained by dividing the plurality of display electrode pairs into N (N is an integer of 2 or more) groups; N sustain electrode driving circuits configured to respectively drive the sustain electrodes of the N display electrode pair groups; a data electrode driving circuit configured to drive the plurality of data electrodes; and a control circuit configured to control the N scan electrode driving circuits, the N sustain electrode driving circuits, and the data electrode driving circuit such that in a case where one field is divided into M (M is an integer of 2 or more) sub-fields SFL (L=1 to M) each including a wall voltage adjusting period in which a wall voltage of the discharge cell is adjusted for address discharge of the discharge cell, an address period in which the address discharge of the discharge cell selected in accordance with an image signal is carried out, and a sustain period in which sustain discharge of the discharge cell in which the address discharge has been carried out is carried out, the sustain period of a K-th sub-field SFK is defined as T1, and the wall voltage adjusting period positioned between the sustain period T1 and the address period of a (K+1)-th sub-field is defined as T2, if T1>(N−1)×T2, a first driving method is used in the sub-field SFK, the first driving method being a method for setting the sustain period and the wall voltage adjusting period in the sub-field SFK for each of the N display electrode pair groups, and if T1<(N−1)×T2, a second driving method is used in the sub-field SFK, the second driving method being a method for setting the sustain periods and the wall voltage adjusting periods in the sub-field SFK such that the sustain periods are synchronized with one another and the wall voltage adjusting periods are synchronized with one another among the N display electrode pair groups.

In accordance with the above configuration, in the first driving method, the address period, the sustain period, and the wall voltage adjusting period are set in one sub-field for each display electrode pair group. Therefore, regarding this sub-field, the address period and the sustain period are set such that the sustain discharge is carried out simultaneously with the address operation which is carried out in a certain display electrode pair group after the address operation is terminated in the other display electrode pair group. With this, the sub-fields, the number of which is necessary for securing adequate image quality, can be set in one field, and adequate luminance can be secured. Meanwhile, in order to adjust the wall voltage for the next address operation, it is desirable that when any one of the display electrode pair groups is in the wall voltage adjusting period, the address operation be restricted in the other display electrode pair groups. In the case of adopting this desirable configuration, when any one of the display electrode pair groups is in the wall voltage adjusting period, the address operation is canceled, and the drive time increases due to this cancel period. As a result, only in a case where the sustain period T1 and the wall voltage adjusting period T2 satisfy a specific condition (T1>(N−1)×T2), the drive time of the first driving method becomes shorter than that of the second driving method. Therefore, the drive time can be shortened by using the first driving method or the second driving method depending on whether or not the sustain period T1 and the wall voltage adjusting period T2 satisfy the specific condition (T1>(N−1)×T2).

The above object, other objects, features and advantages of the present invention will be made clear by the following detailed explanation of preferred embodiments with reference to the attached drawings.

### Advantageous Effects of Invention

In accordance with a plasma display panel driving method according to the present invention and a plasma display apparatus using this driving method, even in the case of an ultra-large ultra-high-definition PDP, the number of sub-fields necessary for realizing high image quality can be adequately secured, and adequate luminance can be obtained.

### BRIEF DESCRIPTION OF DRAWINGS

FIG. 1 is an exploded perspective view showing the configuration of a PDP in Embodiment 1 of the present invention.

FIG. 2 is a diagram showing the arrangement of electrodes of the PDP in Embodiment 1 of the present invention.

FIG. 3 is a sub-field configuration diagram of drive voltage waveforms in Embodiment 1 of the present invention.

FIG. 4 is a diagram for explaining a method for selecting a second driving method or a first driving method in Embodiment 1 of the present invention.

FIG. 5 is a waveform chart of drive voltages applied to respective electrodes of the PDP in Embodiment 1 of the present invention.

FIG. 6 is a waveform chart of drive voltages in the case of applying ramp-shaped erase waveforms in Embodiment 1 of the present invention.

FIG. 7 is a sub-field configuration diagram of other drive voltage waveforms in Embodiment 1 of the present invention.

FIG. 8 is a sub-field configuration diagram of other drive voltage waveforms in Embodiment 1 of the present invention.

FIG. 9 is a sub-field configuration diagram of other drive voltage waveforms in Embodiment 1 of the present invention.

FIG. 10 is a sub-field configuration diagram of other drive voltage waveforms in Embodiment 1 of the present invention.

FIG. 11 is a circuit block diagram of a plasma display apparatus in Embodiment 1 of the present invention.

FIG. 12 is a circuit diagram of a scan electrode driving circuit of the plasma display apparatus in Embodiment 1 of the present invention.

FIG. 13 is a circuit diagram of a sustain electrode driving circuit of the plasma display apparatus in Embodiment 1 of the present invention.

FIG. 14 is a diagram showing the arrangement of electrodes of the PDP in Embodiment 2 of the present invention.

FIG. 15 is a sub-field configuration diagram of the drive voltage waveforms in Embodiment 2 of the present invention.

FIG. 16 is a diagram for explaining the driving method and a method for setting the number of display electrode pairs in Embodiment 4 of the present invention.

FIG. 17 is a sub-field configuration diagram of the drive voltage waveforms in Embodiment 4 of the present invention.

### DESCRIPTION OF EMBODIMENTS

Hereinafter, embodiments of the present invention will be explained in reference to the drawings.

### Embodiment 1

Configuration of PDP 10

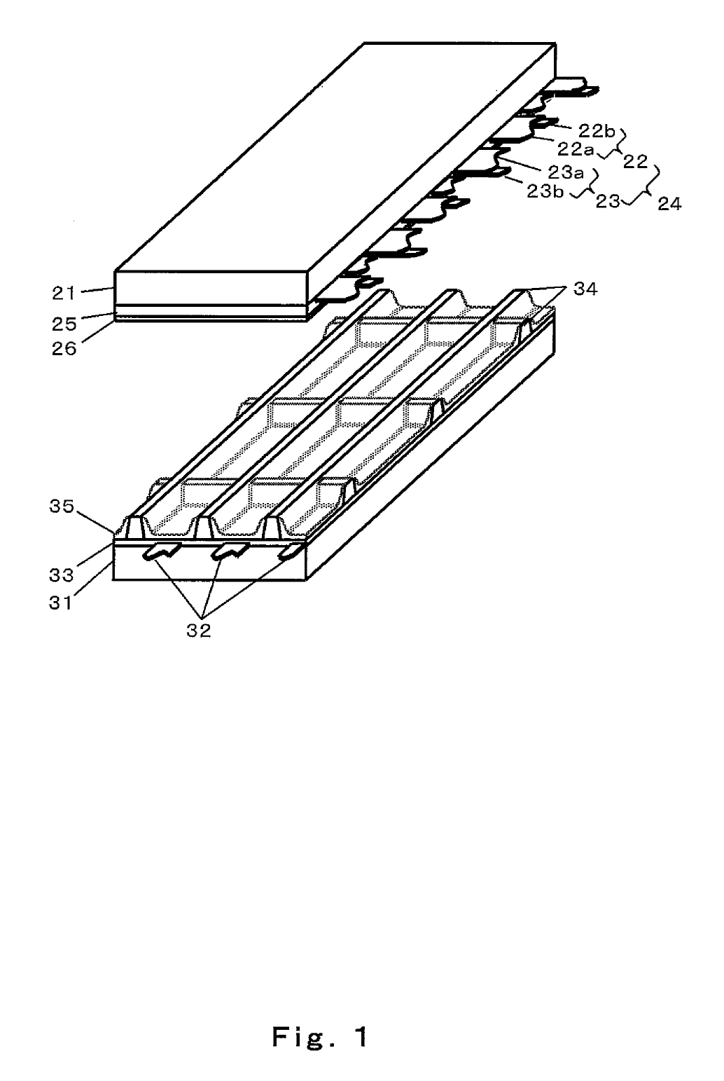

FIG. 1 is an exploded perspective view showing the configuration of a PDP 10 according to Embodiment 1 of the present invention. As shown in FIG. 1, a plurality of display electrode pairs 24 each including a scan electrode 22 and a sustain electrode 23 are formed on a glass front substrate 21 (first substrate). The scan electrode 22 and the sustain electrode 23 respectively include wide transparent electrodes 22a and 23a in order to obtain light by causing discharge at a discharge gap between the scan electrode 22 and the sustain electrode 23. Narrow bus electrodes 22b and 23b are respectively stacked on the transparent electrodes 22a and 23a so as to be located far from the discharge gap. Moreover, a dielectric layer 25 and a protective layer 26 are stacked and formed on the front substrate 21 so as to cover the scan electrodes 22 and the sustain electrodes 23.

A plurality of data electrodes 32 are formed in parallel with one another on a rear substrate 31 (second substrate). Moreover, a dielectric layer 33 is formed on the rear substrate 31 so as to cover the data electrodes 32, and a grid-like dividing wall 34 is further formed on the dielectric layer 33. In a space formed by an upper surface of the dielectric layer 33 and a side surface of the dividing wall 34, a phosphor layer 35 which emits light of red, green, or blue is provided.

The front substrate 21 and rear substrate 31 formed as above sandwich a minute discharge space and are provided to be opposed to each other such that the display electrode pairs 24 and the data electrodes 32 three-dimensionally cross one another (hereinafter may be referred to as “intersect with one another”), and outer peripheral portions of the front substrate 21 and the rear substrate 31 are sealed by a sealing material, such as glass frit. A noble gas, such as neon, argon, or xenon, or a mixture gas thereof is filled as a discharge gas in the discharge space, and the discharge space is divided into a plurality of spaces by the dividing wall 34. Thus, the PDP 10 according to Embodiment 1 is configured, and discharge cells are formed at portions where the display electrode pairs 24 and the data electrodes 32 intersect with one another. In each discharge cell, ultraviolet generated by gas discharge excites the phosphors, thereby carrying out color display. The configuration of the PDP 10 is not limited to the above configuration. For example, the PDP 10 may include the dividing wall 34 having a stripe pattern.

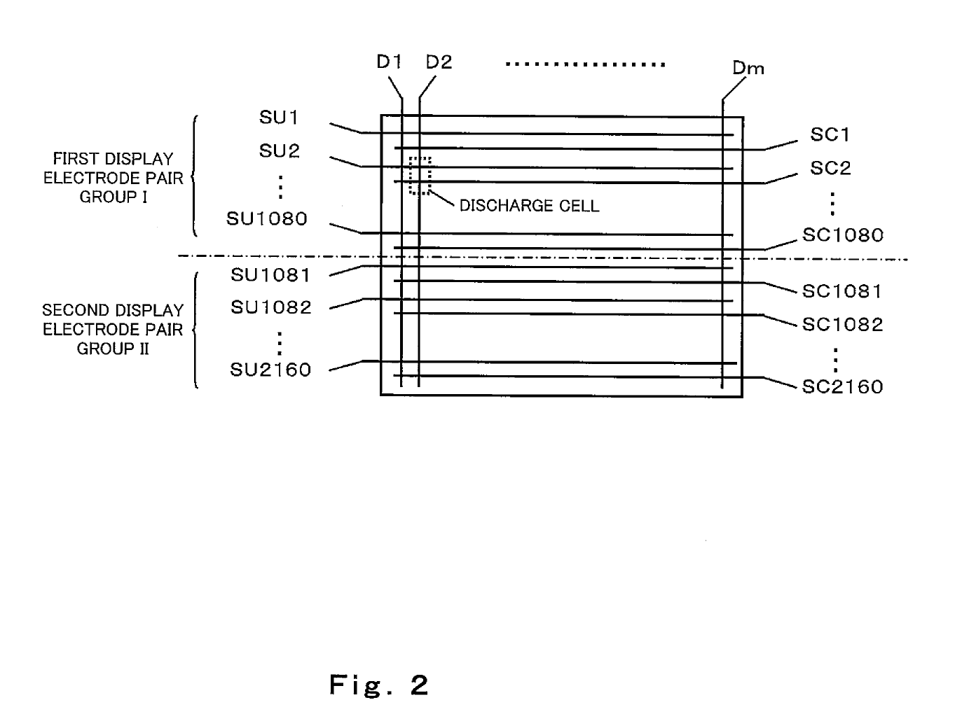

FIG. 2 is a diagram showing the arrangement of electrodes of the PDP 10 in Embodiment 1 of the present invention. As shown in FIG. 2, in the PDP 10 of Embodiment 1, the scan electrodes 22 (SC1 to SC2160) and the sustain electrodes 23 (SU1 to SU2160) are arranged to extend in a row direction, and the data electrodes 32 (D1 to Dm) are arranged to extend in a column direction perpendicular to the row direction. In FIG. 2, the discharge cell is formed at a portion where, for example, a pair of electrodes that are the scan electrode SC2 and the sustain electrode SU2 and one data electrode D2 intersect with one another. As a whole, m×2160 discharge cells are formed in the discharge space. In Embodiment 1, the number of display electrode pairs 24 is 2,160. However, the present embodiment is not limited to this and is not especially limited.

The display electrode pairs 24 (2,160 pairs) formed by the scan electrodes SC1 to SC2160 and the sustain electrodes SU1 to SU2160 are divided into a plurality of display electrode pair groups. As shown in FIG. 2, in Embodiment 1, the PDP 10 is divided into two parts in a vertical direction. The display electrode pairs 24 (the scan electrodes SC1 to SC1080 and the sustain electrodes SU1 to SU1080) located in an upper half part are defined as a first display electrode pair group I, and the display electrode pairs 24 (the scan electrodes SC1081 to SC2160 and the sustain electrodes SU1081 to SU2160) located in a lower half part are defined as a second display electrode pair group II. How to determine the number N of display electrode pair groups will be described later. In Embodiment 1, the PDP 10 is divided into two parts that are upper and lower parts, and two display electrode pair groups are defined. However, two display electrode pair groups may be defined by interlace division based on odd numbers and even numbers. To be specific, the scan electrodes SC1, SC3, . . . SC2159 and the sustain electrodes SU1, SU3, . . . SU2159 may be defined as the first display electrode pair group I, and the scan electrodes SC2, SC4, . . . SC2160 and the sustain electrodes SU2, SU4, . . . SU2160 may be defined as the second display electrode pair group II (not shown). The interlace division is preferable since a luminance difference between the display electrode pair groups is reduced and the image quality improves.

Method for Driving PDP 10

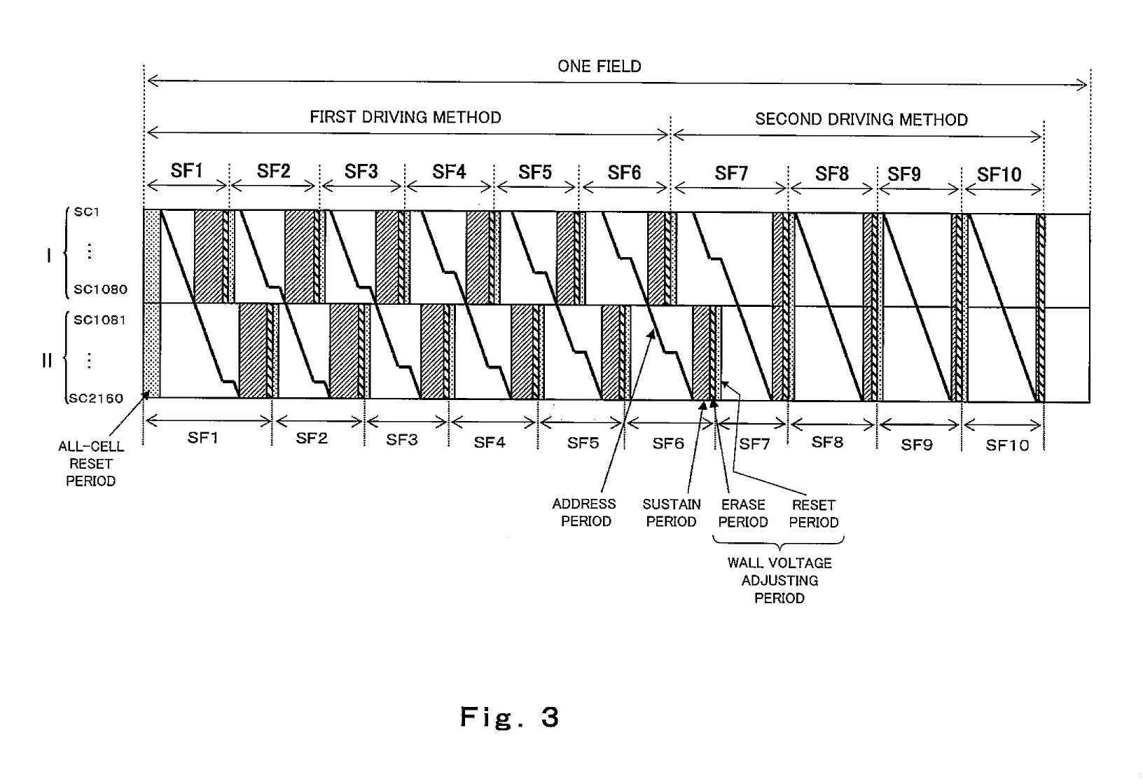

FIG. 3 is a sub-field configuration diagram of drive voltage waveforms applied to the scan electrodes SC1 to SC2160 of the PDP 10 in Embodiment 1 of the present invention. In Embodiment 1, the time (period) of one field is, for example, 16.7 ms. One field period is divided into M (M is an integer of 2 or more) sub-fields SFL (L=1 to M) whose luminance weights are determined. In an example of FIG. 3, one field includes ten sub-fields SF1 to SF10.

Each sub-field includes a reset period, an address period, an erase period, and a sustain period. The reset period is a period in which reset discharge occurs to generate on each electrode a wall voltage (wall charge) necessary for a next address operation. The address period is a period in which address discharge selectively occurs in accordance with a display image to generate on each electrode the wall voltage (wall charge) necessary for next sustain discharge. The sustain period is a period in which the sustain discharge occurs for a time corresponding to the luminance weight. The erase period is a period in which erase discharge occurs to erase an unnecessary wall voltage (wall charge).

Here, functions (roles) of the erase period and the reset period will be considered. These periods may be regarded as periods which are positioned between the sustain period of a certain sub-field and the address period of the next sub-field and in which the wall voltage (wall charge) is adjusted for the next address operation (in order to appropriately carry out the next address operation). Here, in the present invention, a period positioned between the sustain period of a certain sub-field and the address period of the next sub-field is defined as a “wall voltage adjusting period”. In other words, a period which is positioned between the sustain period of a certain sub-field and the address period of the next sub-field and in which the wall voltage (wall charge) is adjusted for the next address operation (in order to appropriately carry out the next address operation) is defined as the “wall voltage adjusting period”. In the example of FIG. 3, the erase period and the subsequent reset period correspond to the wall voltage adjusting period. The sub-field may be configured such that the erase period is omitted. In this case, the wall voltage adjusting period is substantially constituted by only the reset period and is positioned at the beginning of the sub-field. Moreover, the sub-field may be configured such that the erase period gradually shifts to the reset period and a boundary therebetween is unclear. In this case, the wall voltage adjusting period exists over two consecutive sub-fields. Further, the sub-field may be configured such that the erase period and the reset period are executed so as to overlap (partially or entirely overlap) each other in terms of time series or such that the erase period and the reset period are executed mixedly and integrally. In these cases, the wall voltage adjusting period exists over two consecutive sub-fields or is positioned at the beginning of the sub-field.

As shown in FIG. 3, in the method for driving the PDP 10 in Embodiment 1, there are the sub-fields (SF7 to SF10) in each of which the sustain period and wall voltage adjusting period of the first display electrode pair group I are at least synchronized with those of the second display electrode pair group II. To be specific, in each of such sub-fields, the address period, the sustain period, and the wall voltage adjusting period are completely separated from one another in terms of time. Such sub-field driving method is called a second driving method.

In each of the sub-fields (SF1 to SF6) other than the sub-fields of the second driving method, the sustain period and the wall voltage adjusting period are provided for each of the first display electrode pair group I and the second display electrode pair group II. Further, in such sub-fields, in periods other than the wall voltage adjusting periods, the address periods are provided such that the address operation is consecutively carried out in either one of the display electrode pair groups. Such sub-field driving method is called a first driving method. Regardless of whether the driving method is the first driving method or the second driving method, the address operation is prohibited (restricted) in a period in which either one of the display electrode pair groups is in the wall voltage adjusting period.

When selecting the first driving method or the second driving method, the length of the sustain period and the length of the wall voltage adjusting period positioned between the sustain period and the address period of the next sub-field are compared with each other for each of the sub-fields of one field, and the driving method by which a drive time is shortened is selected. The following explanation of the embodiment will explain an example in which the wall voltage adjusting period is constituted by the erase period and the reset period, that is, the wall voltage adjusting period equals the erase period plus the reset period.

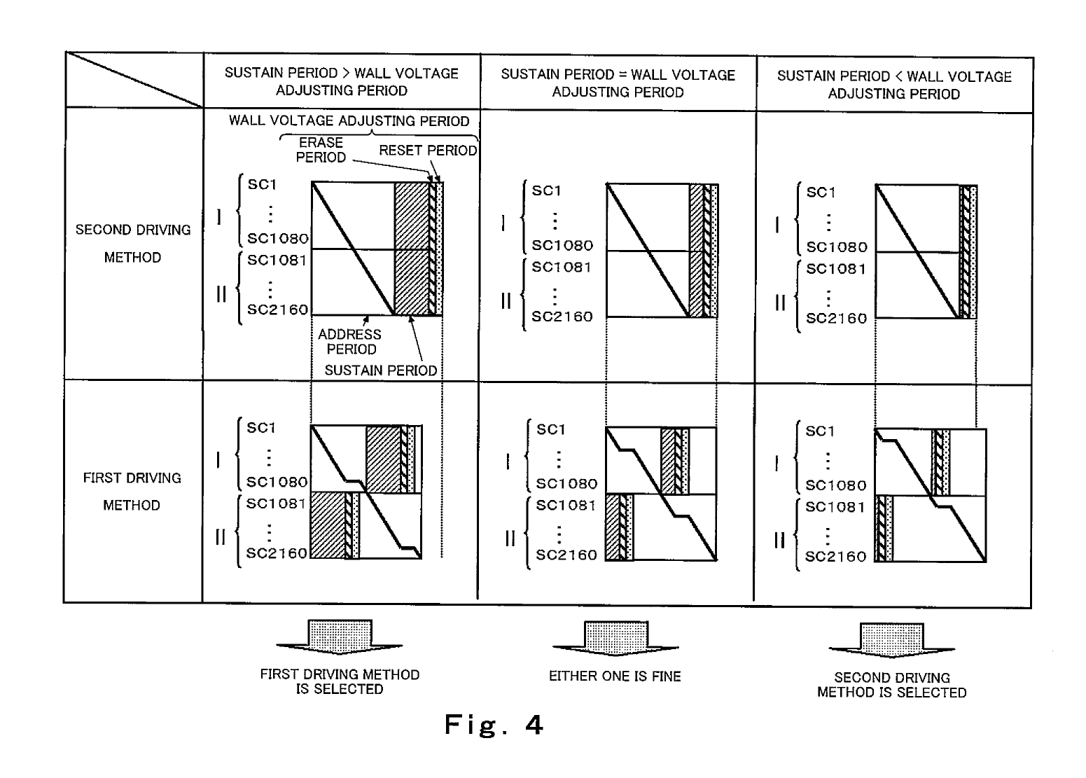

FIG. 4 is a diagram for explaining selection of the first driving method or the second driving method in Embodiment 1 of the present invention. The drive time of the sub-field by the second driving method shown in FIG. 4 can be represented by Formula 1, and the drive time of the sub-field by the first driving method shown in FIG. 4 can be represented by Formula 2. The drive time of the sub-field indicates a time from the start of the address period of a certain sub-field until the end of the wall voltage adjusting period positioned between the sustain period of the certain sub-field and the address period of the next sub-field.

Formula 1: Drive Time by Second Driving Method=Address Period+Sustain Period+Wall Voltage Adjusting Period

Formula 2: Drive Time by First Driving Method=Address Period+Wall Voltage Adjusting Period×2

Based on the above, a difference between the drive time by the second driving method and the drive time by the first driving method can be represented by Formula 3.

Formula 3: Drive Time Difference=Sustain Period (T1)−Wall Voltage Adjusting Period (T2)

As a result, the first driving method is selected in a case where the sustain period (T1) is longer than the wall voltage adjusting period (T2), and the second driving method is selected in a case where the sustain period (T1) is shorter than the wall voltage adjusting period (T2). Thus, the drive time of the sub-field can be shortened.

To be precise, the wall voltage adjusting period in Formula 1 and the wall voltage adjusting period in Formula 2 are different from each other. However, the lengths of respective wall voltage adjusting periods are substantially the same as one another except for a below-described all-cell reset period. Moreover, herein, the wall voltage adjusting period (T2) equals the erase period (T3) plus the reset period (T4).

Specific Effects Obtained by Selecting First Driving Method or Second Driving Method

In the case of a ramp-shaped erase discharge waveform and reset discharge waveform, the wall voltage adjusting period (Erase Period+Reset Period) requires 155 μs. Therefore, in a case where a sustain pulse width is 5 μs, the second driving method is selected in the sub-field in which the number of sustain pulses is 31 or smaller, and the first driving method is selected in the sub-field in which the number of sustain pulses is 32 or larger. In a case where there is no drive time difference between the second driving method and the first driving method, either one may be fine.

For example, in order to obtain adequate luminance in the PDP using the discharge gas such as 90% of Ne−10% of Xe, about 765 sustain pulses are necessary in one field. In this case, the numbers of sustain pulses in respective sub-fields are “242”, “179”, “131”, “90”, “54”, “33”, “18”, “9”, “6”, and “3” in order of SF1 to SF10. Therefore, in a case where the second driving method is used in SF7 to SF10 in each of which the number of sustain pulses is 31 or smaller, the drive time can be reduced by 425 μs as compared to a case where the first driving method is used in all of SF1 to SF10.

In the case of using the PDP using the discharge gas which is high in Xe partial-pressure ratio or in a case where adequate luminance is not required, such as in a cinema mode or a power reduction mode, the number of sustain pulses can be reduced. Therefore, the number of sub-fields in which the second driving method can be selected increases, and this can further shorten the drive time. As a result, the shortened amount of the drive time can be used for the drive margin or the image quality improvement.

Specific Example of Method For Driving PDP 10

The method for driving the PDP 10 in Embodiment 1 will be explained in reference to FIG. 3. In FIG. 3, one field period is divided into SF1 to SF10. However, the present embodiment is not limited to this.

As shown in FIG. 3, first, the all-cell reset period is provided in the first sub-field (SF1) of one field, and the reset discharge is concurrently carried out in all the discharge cells.

Next, in the first display electrode pair group I, the scan pulse is sequentially applied to the scan electrodes SC1 to SC1080 to start the address period of SF1. At this time, it is desirable that the scan pulse be applied as short as possible and as consecutively as possible such that the address operation is consecutively carried out. Although details will be described later, in the address period of the first display electrode pair group I, the second display electrode pair group II is in a break period in which discharge does not occur.

After the termination of the address period of SF1 of the first display electrode pair group I, the sustain period of SF1 and the wall voltage adjusting period positioned between the sustain period of SF1 and the address period of the next sub-field are compared with each other, that is, the sustain period of SF1 and a total of the erase period of SF1 and the reset period of SF2 are compared with each other. In FIG. 3, since the sustain period of SF1 is longer than the wall voltage adjusting period, the first driving method is selected. Therefore, the sustain period of SF1 starts in the first display electrode pair group I, and the address period of SF1 starts in the second display electrode pair group II.

In the first display electrode pair group I, the erase period starts after the termination of the sustain period of SF1, and the erase discharge occurs in the discharge cell which has discharged in the sustain period. After the termination of the erase period, the reset period of SF2 starts, and the reset discharge for the next address operation occurs.

In the wall voltage adjusting period of the first display electrode pair group I, that is, in the erase period and reset period of the first display electrode pair group I, the address operation stops in the second display electrode pair group II. To be specific, in Embodiment 1, when the first display electrode pair group I or the second display electrode pair group II is in the wall voltage adjusting period (the erase period and the reset period), the address operation stops. This is because it is better to fix the voltages of the data electrodes since the erase period and the reset period are not only the periods for erasing the wall voltages but also the periods for adjusting the wall voltages on the data electrodes for the address operation of the next address period.

After the termination of the reset period of SF2 of the first display electrode pair group I, the address operation of SF1 restarts in the second display electrode pair group II. After the termination of the address operation of SF1 of the second display electrode pair group II, the address operation of SF2 starts in the first display electrode pair group I, and the sustain period of SF1 starts in the second display electrode pair group II.

In the second display electrode pair group II, the erase period starts after the termination of the sustain period of SF1, and the erase discharge occurs in the discharge cell which has discharged in the sustain period. After the termination of the erase period, the reset period of SF2 starts, and the reset discharge for the next address operation occurs.

As described above, in the wall voltage adjusting period of the second display electrode pair group II, that is, in the erase period and reset period of the second display electrode pair group II, the address operation stops in the first display electrode pair group I. After the termination of the reset period of SF2 of the second display electrode pair group II, the address operation of SF2 restarts in the first display electrode pair group I.

Thus, the operation of the first driving method is repeated from the all-cell reset period until the termination of the address period of SF7 of the first display electrode pair group I.

After the termination of the address period of SF7 of the first display electrode pair group I, the sustain period of SF7 and the wall voltage adjusting period (Erase Period of SF7+Reset Period of SF8) positioned between the sustain period of SF7 and the address period of the next sub-field are compared with each other. In FIG. 3, since the sustain period of SF7 is shorter than the wall voltage adjusting period, the second driving method is selected. Therefore, after the termination of the address period of SF7 of the second display electrode pair group II, the sustain period of SF7 of the first display electrode pair group I and the sustain period of SF7 of the second display electrode pair group II start in synchronization with each other. Then, since the sustain period is shorter than the wall voltage adjusting period in each of SF7 to SF10, the second driving method is selected in from the sustain period of SF7 until the termination of the erase period of SF10. Thus, one field terminates.

Details and Operations of Drive Voltage Waveforms of PDP 10

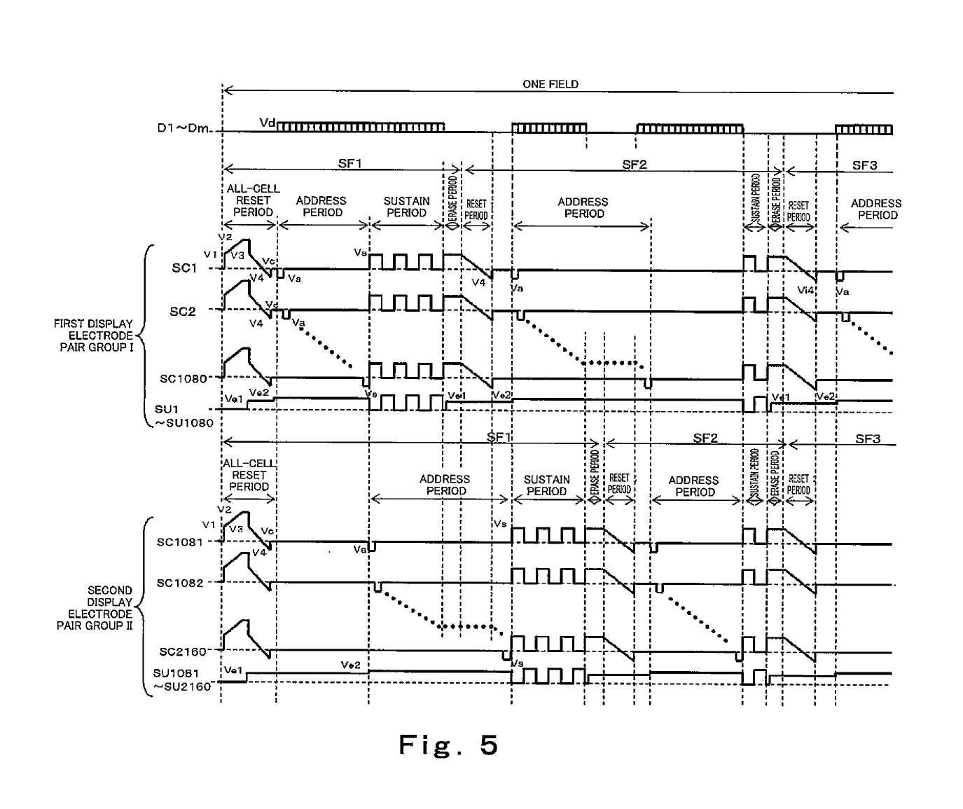

FIG. 5 is a waveform chart of drive voltages applied to respective electrodes of the PDP 10 in Embodiment 1 of the present invention. As described above, in Embodiment 1, the all-cell reset period in which the reset discharge occurs in all the discharge cells is provided in the first sub-field (SF1) of one field. Moreover, after the sustain period of each sub-field in each of the first display electrode pair group I and the second display electrode pair group II, the erase period in which the erase discharge occurs in the discharge cell which has discharged in the sustain period and the reset period in which the reset discharge occurs in the next sub-field are provided. FIG. 5 shows a case where the first driving method is used in SF1 and the second driving method is used in SF2. However, the present embodiment is not limited to this.

As shown in FIG. 5, in the all-cell reset period, first, 0 V is applied to the data electrodes D1 to Dm and the sustain electrodes SU1 to SU2160. A ramp waveform voltage is applied to the scan electrodes SC1 to SC2160. The ramp waveform voltage is a voltage which moderately increases from a voltage V1 toward a voltage V2. The voltage V1 is equal to or lower than a discharge start voltage with respect to the sustain electrodes SU1 to SU2160 and the data electrodes D1 to Dm, and the voltage V2 exceeds the discharge start voltage. While the ramp waveform voltage is rising, weak reset discharge occurs between the scan electrodes SC1 to SC2160 and the sustain electrodes SU1 to SU2160 and between the scan electrodes SC1 to SC2160 and the data electrodes D1 to Dm. Thus, a negative wall voltage is accumulated on each of the scan electrodes SC1 to SC2160, and a positive wall voltage is accumulated on each of the data electrodes D1 to Dm and the sustain electrodes SU1 to SU2160. Here, the wall voltage on the electrode is a voltage generated by the wall charge accumulated on the dielectric layer, the protective layer, the phosphor layer, and the like, which cover the electrodes. In this period, a voltage Vd may be applied to the data electrodes D1 to Dm.

Next, a voltage 0 (V) is applied to the data electrodes D1 to Dm, and a positive voltage Ve1 is applied to the sustain electrodes SU1 to SU2160. A ramp waveform voltage is applied to the scan electrodes SC1 to SC2160. The ramp waveform voltage is a voltage which moderately decreases from a voltage V3 toward a voltage V4. The voltage V3 is equal to or lower than the discharge start voltage with respect to the sustain electrodes SU1 to SU2160 and the data electrodes D1 to Dm, and the voltage V4 exceeds the discharge start voltage. While the ramp waveform voltage is falling, weak reset discharge occurs between the scan electrodes SC1 to SC2160 and the sustain electrodes SU1 to SU2160 and between the scan electrodes SC1 to SC2160 and the data electrodes D1 to Dm. Thus, the negative wall voltage on each of the scan electrodes SC1 to SC2160 and the positive wall voltage on each of the sustain electrodes SU1 to SU2160 are weakened, and the positive wall voltage on each of the data electrodes D1 to Dm is adjusted to a value appropriate for the address operation.

Then, a voltage Vc is applied to the scan electrodes SC1 to SC2160. Thus, the reset operation is terminated, in which the reset discharge is carried out in all the discharge cells.

After the termination of the all-cell reset period, the address period of SF1 starts in the first display electrode pair group I. This addressing is sequentially carried out with respect to 1,080 lines by a single scan method as below. Specifically, a positive voltage Ve2 is applied to the sustain electrodes SU1 to SU1080. The scan pulse having a negative voltage Va is applied to the scan electrode SC1 of the first line, and the address pulse having the positive voltage Vd is applied to a data electrode Dk (k is any one of 1 to m) of the discharge cell which should emit light. At this time, a voltage difference at a portion where the data electrode Dk and the scan electrode SC1 intersect with each other is a value obtained by adding a difference between the wall voltage on the data electrode Dk and the wall voltage on the scan electrode SC1 to a difference (Address Pulse Voltage Vd−Scan Pulse Voltage Va) between externally applied voltages, and this voltage difference exceeds the discharge start voltage. Thus, the discharge starts between the data electrode Dk and the scan electrode SC1, this proceeds to the discharge between the sustain electrode SU1 and the scan electrode SC1, and the address discharge occurs. As a result, the positive wall voltage is accumulated on the scan electrode SC1, and the negative wall voltage is accumulated on each of the sustain electrode SU1 and the data electrode Dk.

In contrast, since a voltage at a portion where the data electrode to which the address pulse voltage Vd is not applied and the scan electrode SC1 intersect with each other does not exceed the discharge start voltage, the address discharge does not occur.

Next, the scan pulse voltage Va is applied to the scan electrode SC2 of the second line, and the address pulse voltage Vd is applied to the data electrode Dk of the discharge cell which should emit light. At this time, in the discharge cell of the second line to which the scan pulse voltage Va and the address pulse voltage Vd are applied at the same time, the address discharge occurs, and the address operation is carried out.

The address operation is repeated until the discharge cell of the 1,080th line of the first display electrode pair group I, and the address discharge selectively occurs in the discharge cells which should emit light. Thus, the wall charge is generated on each electrode.

In the address period of the first display electrode pair group I, the second display electrode pair group II is in the break period in which the discharge does not occur while the voltage Vc is being applied to the scan electrodes SC1081 to SC2160 of the second display electrode pair group II, and the voltage Ve1 is being applied to the sustain electrodes SU1081 to SU2160 of the second display electrode pair group II.

After the termination of the address operation with respect to the scan electrode SC1080 of the 1,080th line of SF1, the sustain period of SF1 and the wall voltage adjusting period (Erase Period of SF1+Reset Period of SF2) positioned between the sustain period of SF1 and the address period of the next sub-field are compared with each other. For example, if the number of sustain pulses of SF1 is 90, the sustain period of SF1 is 450 μs (=90×5 μs), and the wall voltage adjusting period (Erase Period of SF1+Reset Period of SF2) is 150 μs. Thus, the sustain period of SF1 is longer than the wall voltage adjusting period. Therefore, the first driving method is selected, and the sustain period of SF1 of the first display electrode pair group I and the address period of SF1 of the second display electrode pair group II start at the same time.

In the sustain period of SF1 of the first display electrode pair group I, the sustain pulse, the number of which is, for example, 90, is alternately applied to the scan electrodes SC1 to SC1080 and the sustain electrodes SU1 to SU1080, and the discharge cell in which the address discharge has occurred is caused to emit light. The specific operation in the sustain period is described below.

First, the sustain pulse having a positive voltage Vs is applied to the scan electrodes SC1 to SC1080, and 0 V is applied to the sustain electrodes SU1 to SU1080. At this time, in the discharge cell in which the address discharge has occurred, the voltage difference between a scan electrode SCi (i is any one of 1 to 1,080) and a sustain electrode SUi (i is any one of 1 to 1,080) is a value obtained by adding a difference between the wall voltage on the scan electrode SCi and the wall voltage on the sustain electrode SUi to the sustain pulse voltage Vs, and this voltage difference exceeds the discharge start voltage. Thus, the sustain discharge occurs between the scan electrode SCi and the sustain electrode SUi and excites the discharge gas. The phosphor layer 35 emits light by the ultraviolet generated when the excited discharge gas transits to a stable state. As a result, the negative wall voltage is accumulated on the scan electrode SCi, and the positive wall voltage is accumulated on the sustain electrode SUi.

In contrast, the sustain discharge does not occur in the discharge cell in which the address discharge has not occurred in the address period, and the wall voltage on each electrode at the time of the termination of the reset period is maintained.

Next, 0 V is applied to the scan electrodes SC1 to SC1080, and the positive sustain pulse voltage Vs is applied to the sustain electrodes SU1 to SU1080. At this time, since the voltage difference between the sustain electrode SUi and the scan electrode SCi exceeds the discharge start voltage in the discharge cell in which the sustain discharge has occurred, the sustain discharge occurs again between the sustain electrode SUi and the scan electrode SCi. As a result, the negative wall voltage is accumulated on the sustain electrode SUi, and the positive wall voltage is accumulated on the scan electrode SCi.

After that, as with the above, the sustain pulse voltage Vs is alternately applied to the scan electrodes SC1 to SC1080 and the sustain electrodes SU1 to SU1080 to give a potential difference between the scan electrodes SC1 to SC1080 and the sustain electrodes SU1 to SU1080. Thus, the sustain discharge is continuously carried out in the discharge cell in which the address discharge has occurred in the address period.

In the erase period after the termination of the sustain period, a so-called narrow pulse voltage difference is given to between the scan electrodes SC1 to SC1080 and the sustain electrodes SU1 to SU1080, and this erases the wall voltage on the scan electrode SCi and the wall voltage on the sustain electrode SUi while maintaining the positive wall voltage on the data electrode Dk. In Embodiment 1, the erase discharge is realized by applying the voltage Ve1 to the sustain electrodes SU1 to SU1080 immediately after applying the voltage Vs to the scan electrodes SC1 to SC1080.

After the termination of the erase period, the reset period of SF2 starts in the first display electrode pair group I. The positive voltage Ve1 is applied to the sustain electrodes SU1 to SU1080, and the ramp waveform voltage moderately falling from the voltage Vs toward the voltage V4 is applied to the scan electrodes SC1 to SC1080. While the ramp waveform voltage is falling, the weak reset discharge occurs between the scan electrodes SC1 to SC1080 and the sustain electrodes SU1 to SU1080 and between the scan electrodes SC1 to SC1080 and the data electrodes D1 to Dm. Thus, the negative wall voltage on each of the scan electrodes SC1 to SC1080 and the positive wall voltage on each of the sustain electrodes SU1 to SU1080 are weakened, and the positive wall voltage on each of the data electrodes D1 to Dm is adjusted to a value appropriate for the address operation.

Then, the voltage Vc is applied to the scan electrodes SC1 to SC1080. Thus, the reset operation is terminated, in which the reset discharge is carried out in the discharge cells in which the sustain discharge has occurred in SF1.

In the address period of SF1 of the second display electrode pair group II, the positive voltage Ve2 is applied to the sustain electrodes SU1081 to SU2160. The scan pulse having the negative voltage Va is applied to the scan electrode SC1081 of the first line of the second display electrode pair group II, and the address pulse having the positive voltage Vd is applied to the data electrode Dk (k is any one of 1 to m) of the discharge cell which should emit light. At this time, the voltage difference at a portion where the data electrode Dk and the scan electrode SC1081 intersect with each other is a value obtained by adding a difference between the wall voltage on the data electrode Dk and the wall voltage on the scan electrode SC1081 to the difference (Address Pulse Voltage Vd−Scan Pulse Voltage Va) between the externally applied voltages, and this voltage difference exceeds the discharge start voltage. Thus, the discharge starts between the data electrode Dk and the scan electrode SC1081, this proceeds to the discharge between the sustain electrode SU1081 and the scan electrode SC1081, and the address discharge occurs. As a result, the positive wall voltage is accumulated on the scan electrode SC1081, and the negative wall voltage is accumulated on each of the sustain electrode SU1081 and the data electrode Dk.

Next, the scan pulse voltage Va is applied to the scan electrode SC1082 of the second line of the second display electrode pair group II, and the address pulse voltage Vd is applied to the data electrode Dk of the discharge cell which should emit light. At this time, in the discharge cell of the 1,082th line (second line of the second display electrode pair group II) to which the scan pulse voltage Va and the address pulse voltage Vd are applied at the same time, the address discharge occurs, and the address operation is carried out.

The address operation is repeated until the discharge cell of the 2,160th line of the second display electrode pair group II, and the address discharge selectively occurs in the discharge cells which should emit light. Thus, the wall charge is generated on each electrode.

As described above, in Embodiment 1, when the first display electrode pair group I or the second display electrode pair group II is in the wall voltage adjusting period (the erase period and the reset period), the address operation stops. This is because it is better to fix the voltages of the data electrodes since the wall voltage adjusting period (the erase period and the reset period) is not only the period for erasing the wall voltages but also the period for adjusting the wall voltages on the data electrodes for the address operation of the next address period. Therefore, after the termination of the reset period of SF2 of the first display electrode pair group I, the address operation of SF1 restarts in the second display electrode pair group II and is repeated until the discharge cell of the 2,160th line.

In the address period of the first display electrode pair group I after the termination of the reset period of SF2, the positive voltage Ve2 is applied to the sustain electrodes SU1 to SU1080 as with the address period of SF1. The scan pulse voltage Va is sequentially applied to the scan electrodes SC1 to SC1080, and the address pulse voltage Vd is applied to the data electrode Dk of the discharge cell which should emit light. Thus, the address operation is carried out in the discharge cells of the first to 1,080th lines.

The sustain period of SF1 of the second display electrode pair group II starts at the same time as the address period of SF2 of the first display electrode pair group I. Specifically, the sustain pulse, the number of which is, for example, 90, is alternately applied to the scan electrodes SC1081 to SC2160 and the sustain electrodes SU1081 to SU2160, and the discharge cell in which the address discharge has occurred is caused to emit light. The erase period sequentially starts after the termination of the sustain period, and the reset period of SF2 sequentially starts after the termination of the erase period.

As described above, when the second display electrode pair group II is in the wall voltage adjusting period (the erase period and the reset period), the address operation of SF2 of the first display electrode pair group I stops. After the termination of the reset period of SF2 of the second display electrode pair group II, the address operation of SF2 of the first display electrode pair group I restarts and is repeated until the discharge cell of the 1080th line.

Since detailed operations in the sustain period, erase period, and reset period of the second display electrode pair group II are the same as those of the first display electrode pair group I, explanations thereof are omitted.

After the termination of the address operation with respect to the scan electrodes SC1 to SC1080 in SF2 of the first display electrode pair group I, the sustain period of SF2 and the wall voltage adjusting period (Erase Period of SF2+Reset Period of SF3) positioned between the sustain period of SF2 and the address period of the next sub-field are compared with each other. For example, if the number of sustain pulses of SF2 is nine, the sustain period of SF2 is 45 μs (=9×5 μs), and the wall voltage adjusting period (Erase Period of SF2+Reset Period of SF3) is 150 μs. Thus, the sustain period of SF2 is shorter than the wall voltage adjusting period. Therefore, the second driving method is selected, and the address period of SF2 of the second display electrode pair group II continues.

After the address operation of SF2 of the second display electrode pair group II is terminated up to the discharge cell of the 2,160th line, the sustain period concurrently starts in all the discharge cells. To be specific, the sustain pulse, the number of which is nine, is alternately applied to the scan electrodes SC1 to SC2160 and the sustain electrodes SU1 to SU2160, and the discharge cell in which the address discharge has occurred is caused to emit light.

In the erase period after the termination of the sustain period, a so-called narrow pulse voltage difference is given to between the scan electrodes SC1 to SC2160 and the sustain electrodes SU1 to SU2160, and this erases the wall voltages on the scan electrode SCi and the sustain electrode SUi while maintaining the positive wall voltage on the data electrode Dk.

After the termination of the erase period, the reset period of SF3 starts. The positive voltage Ve1 is applied to the sustain electrodes SU1 to SU2160, and the ramp waveform voltage moderately falling from the voltage Vs toward the voltage V4 is applied to the scan electrodes SC1 to SC2160. While the ramp waveform voltage is falling, weak reset discharge occurs between the scan electrodes SC1 to SC2160 and the sustain electrodes SU1 to SU2160 and between the scan electrodes SC1 to SC2160 and the data electrodes D1 to Dm. Thus, the negative wall voltage on each of the scan electrodes SC1 to SC2160 and the positive wall voltage on each of the sustain electrodes SU1 to SU2160 are weakened, and the positive wall voltage on each of the data electrodes D1 to Dm is adjusted to a value appropriate for the address operation.

Then, the voltage Vc is applied to the scan electrodes SC1 to SC2160. Thus, the reset operation is terminated, in which the reset discharge is carried out in the discharge cells in which the sustain discharge has occurred in SF2.

After that, as with the above, the address period of SF3 of the first display electrode pair group I starts, and the sustain period of SF3 and the wall voltage adjusting period (Erase Period of SF3+Reset Period of SF4) positioned between the sustain period of SF3 and the address period of the next sub-field are compared with each other. Then, the first driving method or the second driving method is selected. The second driving method is selected in the last SF10, and one field period terminates.

Although not shown, in order to further stabilize the discharge in the all-cell reset period of the next field, the reset period may be provided between the erase period of SF10 and the all-cell reset period of SF1.

Moreover, since the voltage Ve2 and the voltage Ve1 are close to each other, the voltage Ve2 may be replaced with the voltage Ve1 for simplification of the driving circuit.

As above, in Embodiment 1, for each of a plurality of sub-fields in one field, the sustain period and the wall voltage adjusting period (Erase Period+Reset Period) positioned between this sustain period and the address period of the next sub-field are compared with each other, and the first driving method or the second driving method can be selected. With this, the drive time can be shortened.

Modification Example

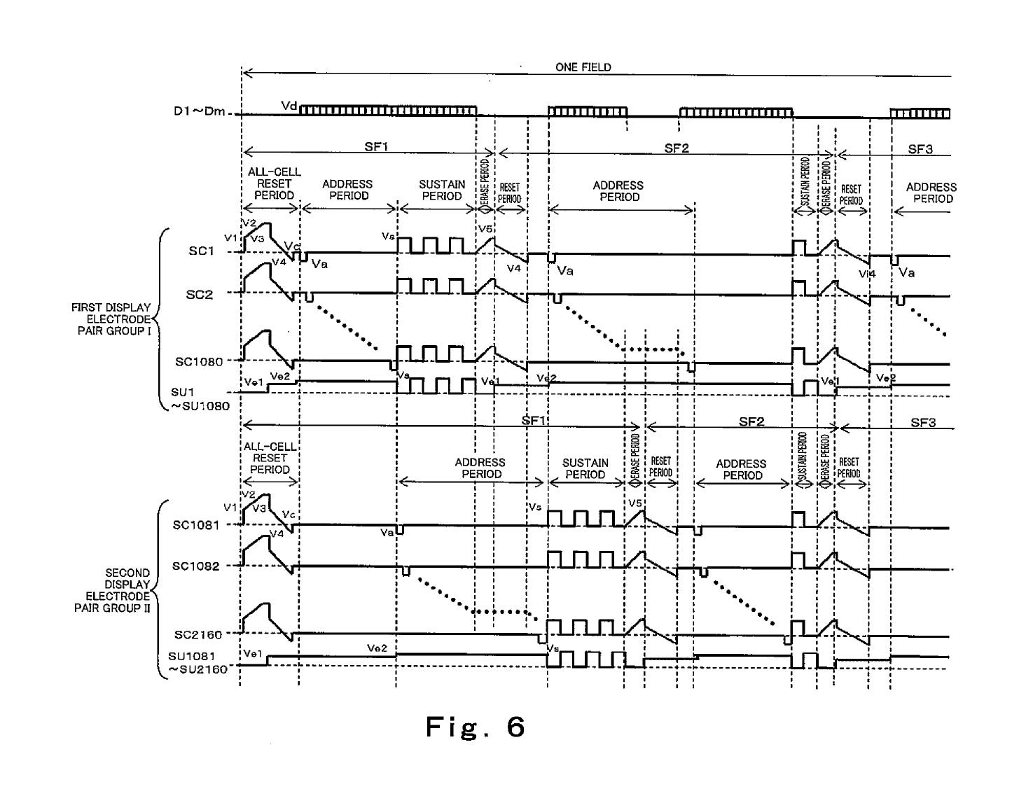

FIG. 6 is a waveform chart of drive voltages in the case of applying ramp-shaped erase waveforms in Embodiment 1 of the present invention. As shown in FIG. 6, the ramp waveform voltage moderately rising up to a voltage V5 is applied to the scan electrode SCi in the erase period, and the ramp waveform voltage moderately falling up to the voltage V4 is applied to the scan electrode SCi in the next reset period. In accordance with this method, although a time required for the erase period is longer than that in FIG. 5, it is possible to further precisely control the wall voltage on each electrode, make the address discharge of the next sub-field small, and suppress discharge cross talk between the discharge cells.

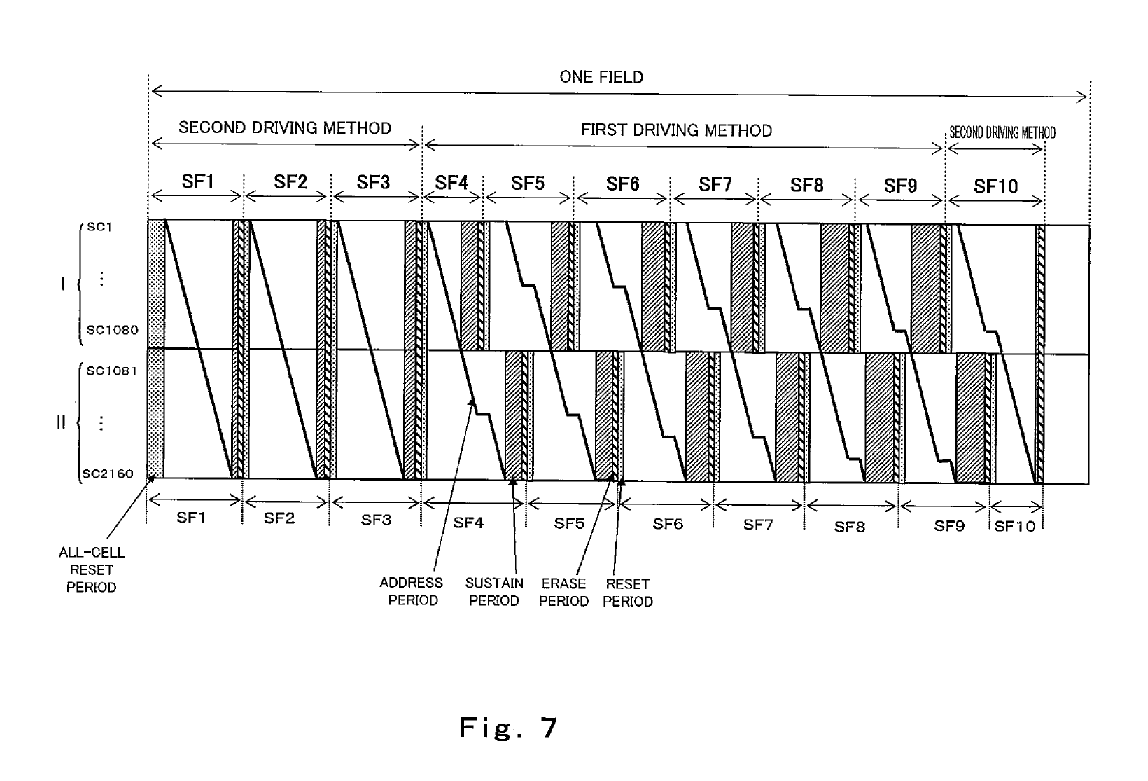

FIG. 7 is a sub-field configuration diagram of other drive voltage waveforms in Embodiment 1 of the present invention. In FIG. 3, the number of sustain pulses decreases from SF1 to SF10, which is a descending order. However, in FIG. 7, although the number of sustain pulses in the last SF10 is the smallest, which is the same as FIG. 3, the number of sustain pulses (sustain period) increases from SF1 to SF9, which is an ascending order. Effects obtained by this method will be explained below.

Originally, in the plasma display, the longer a waiting time from the termination of the reset discharge until the next address discharge is, the more the wall charge accumulated by the reset discharge disappears and address failures tend to occur. Therefore, it is better to carry out the address discharge immediately after the reset discharge. In a case where the numbers of sustain pulses are set in the descending order, the address discharge is immediately carried out in the sub-field in which the luminance weight is high. However, in the sub-field in which the luminance weight is low, the waiting time until the address discharge is long, and the address failure tends to occur. However, as shown in FIG. 7, in a case where the numbers of sustain pulses are set in the ascending order, it is possible to carry out the address discharge immediately after the reset discharge in the sub-field in which the luminance weight is low. Therefore, the address discharge can be stably carried out.

Moreover, in FIG. 7, sub-field signal processing is carried out such that when light is emitted in the sub-field in which the luminance weight is high (the number of sustain pulses is large), light is emitted in one or more sub-fields in which the luminance weight is low (the number of sustain pulses is small). In accordance with this method, the address discharge can be carried out immediately after the reset discharge in both the sub-field in which the luminance weight is high and the sub-field in which the luminance weight is low. Therefore, the address discharge can be stably carried out.

As shown in FIGS. 3 and 7, the reasons why the sub-field in which the luminance weight is the lowest and light is most likely to be emitted is provided as the last SF10 are because (1) the drive time is shortened, (2) even if lighting failure occurs, the lowest luminance is less obtrusive, and (3) by providing the all-cell reset period immediately after SF10, means for reducing the drive margin and lowering the lowest luminance to improve a low-tone characteristic can be used.

Such sub-field configuration in which the sub-field in which the luminance weight is the lowest is provided immediately before the all-cell reset period (in the case of the all-cell reset period of a P-th (P is an integer) field, the sub-field in which the luminance weight is the lowest is provided as a last sub-field SFM of a (P−1)-th field) is conventionally known. However, although the sub-field in which the luminance weight is the lowest is conventionally provided as the first SF1, it is provided as the last SF10 in FIG. 7. In accordance with this method, as compared to the conventional method, the waiting time from the termination of the all-cell reset discharge until the address discharge of the sub-field in which the luminance weight is the lowest is shortened, and the address discharge of the sub-field in which the luminance weight is the lowest can be stably carried out.

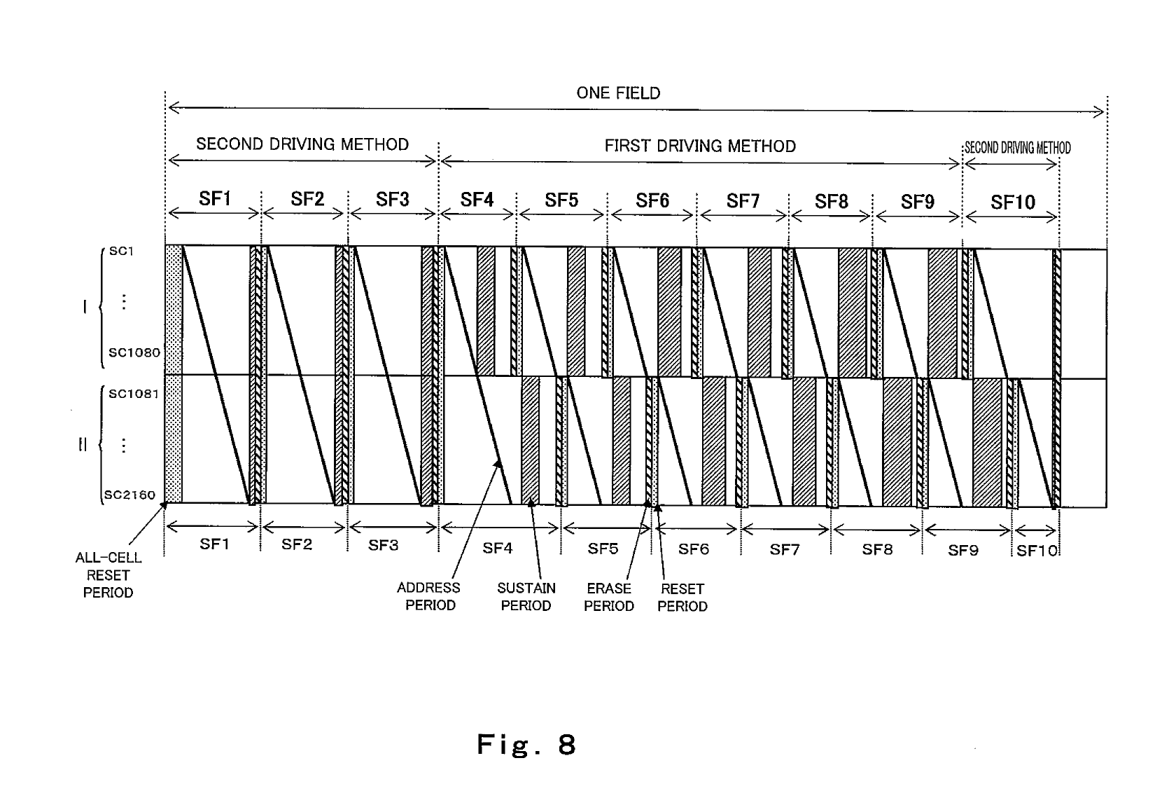

FIG. 8 is a sub-field configuration diagram of other drive voltage waveforms in Embodiment 1 of the present invention. Each of FIGS. 3 and 7 shows a case where the erase period is provided immediately after the sustain period, but FIG. 8 shows a case where the erase period and the reset period are provided immediately before the address period. In accordance with this method, the waiting time from the termination of the reset discharge until the next address discharge is shortened, and the address discharge can be stably carried out.

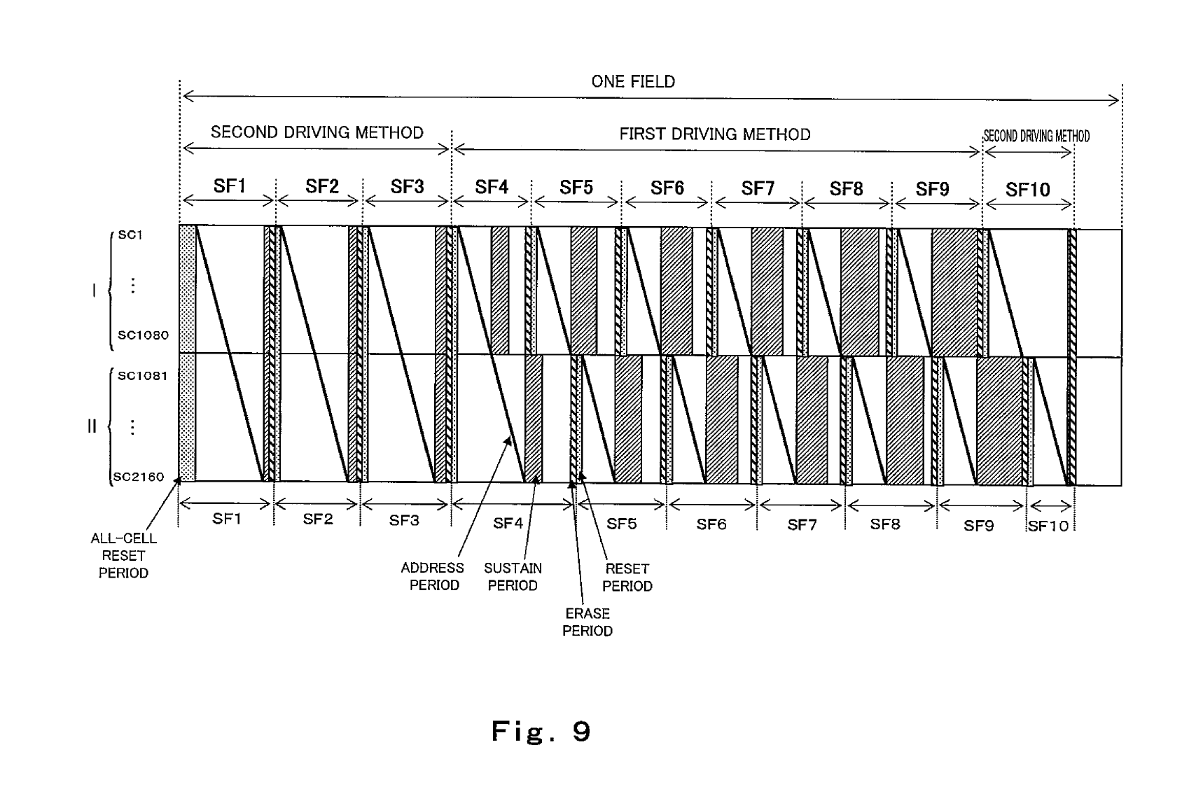

FIG. 9 is a sub-field configuration diagram of other drive voltage waveforms in Embodiment 1 of the present invention. In FIG. 9, the erase period and the reset period are provided immediately before the address period as with FIG. 8. In addition, a sustain operation is carried out in the second display electrode pair group II when the first display electrode pair group I is in the erase period and the reset period, and the sustain operation is carried out in the first display electrode pair group I when the second display electrode pair group II is in the erase period and the reset period. The period in which the sustain operation is carried out in one of the display electrode pair groups may be in a period in which the other display electrode pair group is in the erase period or the reset period. In accordance with this method, since the number of sustain pulses in one field can be further increased, the luminance and the tone can be further improved.

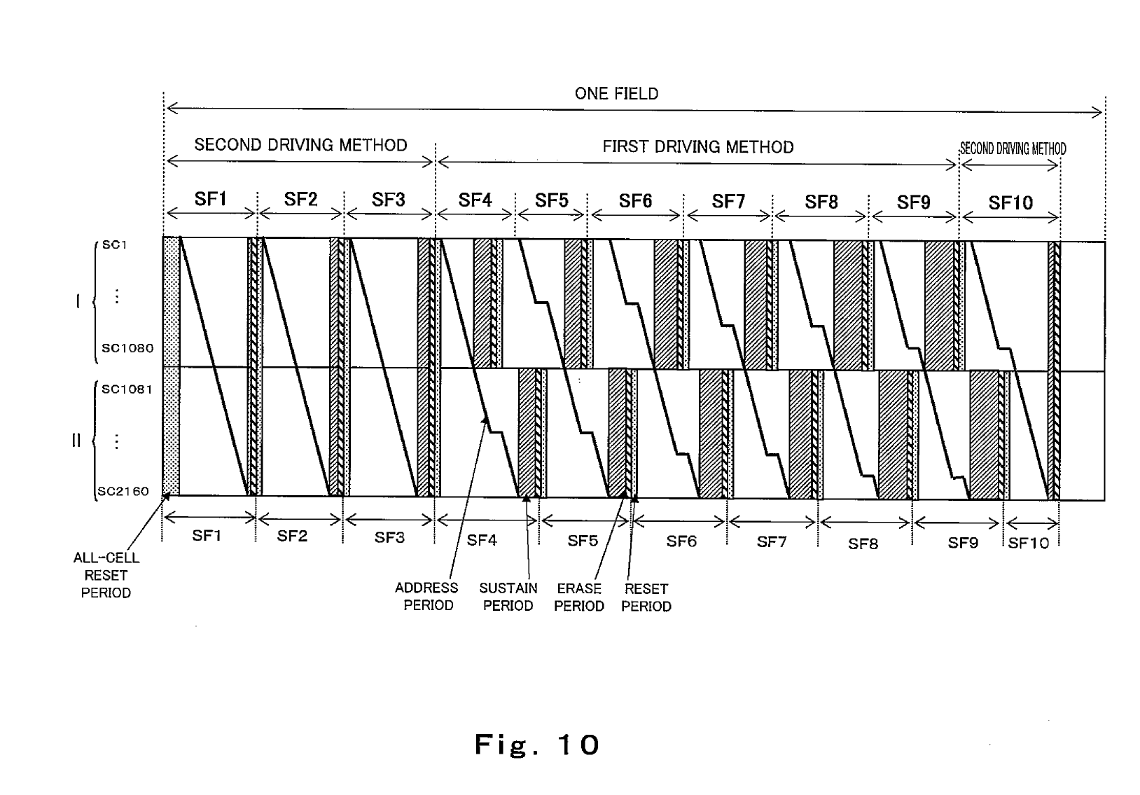

FIG. 10 is a sub-field configuration diagram of other drive voltage waveforms in Embodiment 1 of the present invention. The PDP has the problem that the address discharge after the all-cell reset discharge is strong and the discharge cross talk tends to occur between the discharge cells. Here, in FIG. 10, the luminance weights of the first SF1 and last SF10 in FIG. 7 are replaced with each other. Thus, the first SF1 is the sub-field in which the luminance weight is the lowest, and the last SF10 is the sub-field in which the luminance weight is the second lowest. Such sub-field configuration is realized, and light is always emitted in SF1 when light is emitted in SF2 and the following (in other words, light is always emitted in SF1 except for 0 tone). With this, the discharge cross talk between the discharge cells can be suppressed while minimizing the reduction in power of expression of the low luminance tone. The method of FIG. 8 or 9 can be applied to this method.

Moreover, in addition to a case where the sustain periods of the sub-fields SF1 to SF10 of one field are simply set in the ascending or descending order and a case where the sub-field in which the luminance weight is the lowest is provided as the last SF10 and the other SF1 to SF9 are set in the ascending order as shown in FIGS. 3 and 7 to 9, it is possible to use a case where the ascending order is repeated twice in one field (hereinafter referred to as “twice ascending order”) or a case where the descending order is repeated twice in one field (hereinafter referred to as “twice descending order”). With this, the waiting time from the termination of the all-cell reset discharge until the address discharge of each sub-field is uniformized, and stabilization of the address discharge of each sub-field is expected.

As an example of the twice ascending order, the numbers of sustain pulses of respective sub-fields are “1”, “2”, “4”, “11”, “22”, “44”, “5”, “7”, “20”, and “42” in order of the first SF1 to the last SF10. In this case, SF1 that is the first sub-field (in which the luminance weight is the lowest in a first ascending order arrangement of the twice ascending order) of the first ascending order arrangement and SF7 that is the first sub-field (in which the luminance weight is the lowest in a second ascending order arrangement of the twice ascending order) of the second ascending order arrangement may be set such that light is always emitted in SF1 and SF7 (light is always emitted in SF1 and SF7 on an image screen except for 0 tone, that is, all-black display).

Moreover, as another example of the twice ascending order, the sub-field in which the luminance weight is the lowest may be set as the last SF10. In this example, the numbers of sustain pulses of respective sub-fields are “2”, “4”, “11”, “22”, “44”, “5”, “7”, “20”, “42”, and “1” in order of the first SF1 to the last SF10. Moreover, in this case, SF7 that is the sub-field in which the luminance weight is the second lowest in the second ascending order arrangement of the twice ascending order may be set such that light is always emitted in SF7.

Moreover, as an example of the twice descending order, the numbers of sustain pulses of respective sub-fields are “44”, “22”, “11”, “4”, “2”, “1”, “42”, “20”, “7”, and “5” in order of the first SF1 to the last SF10.

Configuration of Plasma Display Apparatus 100

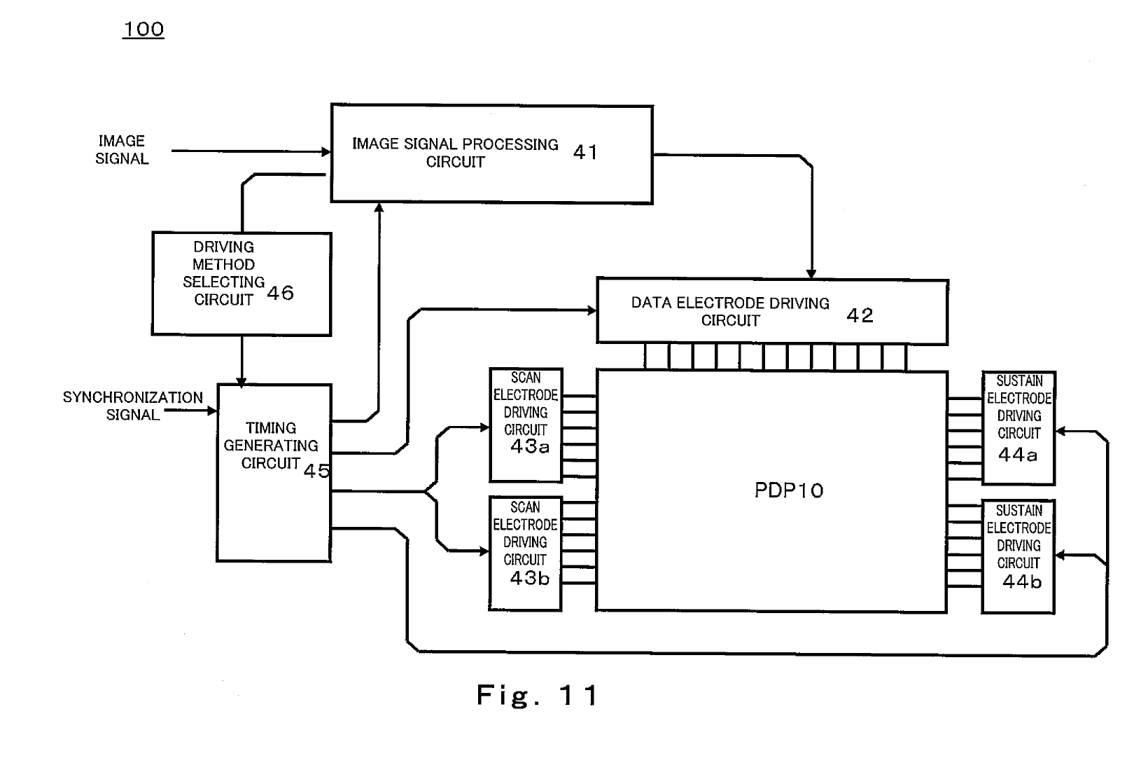

FIG. 11 is a circuit block diagram of a plasma display apparatus 100 in Embodiment 1 of the present invention. As shown in FIG. 11, the plasma display apparatus 100 of Embodiment 1 includes the PDP 10, an image signal processing circuit 41, a data electrode driving circuit 42, scan electrode driving circuits 43a and 43b, sustain electrode driving circuits 44a and 44b, a timing generating circuit 45, a driving method selecting circuit 46, and a power supply circuit (not shown) configured to supply power supply necessary for respective circuit blocks. A control circuit according to the present invention is realized by the image signal processing circuit 41, the timing generating circuit 45, and the driving method selecting circuit 46.

The image signal processing circuit 41 converts an input image signal into image data based on a timing signal supplied from the timing generating circuit 45. The image data indicates light emission or light non-emission of each sub-field. The data electrode driving circuit 42 includes m switches to apply the address pulse voltage Vd or 0 V to the data electrodes D1 to Dm. The data electrode driving circuit 42 converts the image data, output from the image signal processing circuit 41, into an address pulse corresponding to each of the data electrodes D1 to Dm and applies the address pulse to the data electrodes D1 to Dm.

The driving method selecting circuit 46 includes a calculating portion (not shown) and a selecting portion (not shown). The calculating portion calculates and outputs the sustain period of each sub-field based on the number of sustain pulses of each sub-field, the number being transmitted from the image signal processing circuit 41. The selecting portion compares the sustain period output from the calculating portion with the wall voltage adjusting period (Erase Period+Reset Period) positioned between this sustain period and the address period of the next sub-field in order of a plurality of sub-fields of one field, and selects the first driving method or the second driving method as the driving method of each sub-field.

Based on horizontal synchronization signals, vertical synchronization signals, and driving method selection information, the timing generating circuit 45 generates various timing signals for controlling the operations of the image signal processing circuit 41, the data electrode driving circuit 42, the scan electrode driving circuits 43a and 43b, and the sustain electrode driving circuits 44a and 44b. The timing generating circuit 45 then transmits the timing signals to respective circuits. Specifically, the timing generating circuit 45 generates a field start signal after a certain time has elapsed since a vertical synchronization signal V. Then, using this field start signal as a starting point, the timing generating circuit 45 generates the timing signal specifying the start of each of the reset period, address period, sustain period, and erase period of each sub-field. Further, using the timing signal specifying the start of each period as a starting point, the timing generating circuit 45 counts a clock to generate the timing signals specifying the timings of the pulse generations and supply the timing signals to respective driving circuits 41, 42, 43a, 43b, 44a, and 44b.

The scan electrode driving circuit 43a drives the scan electrodes SC1 to SC1080 of the first display electrode pair group I based on the timing signal transmitted from the timing generating circuit 45. The scan electrode driving circuit 43b drives the scan electrodes SC1081 to SC2160 of the second display electrode pair group II based on the timing signal transmitted from the timing generating circuit 45. The sustain electrode driving circuit 44a drives the sustain electrodes SU1 to SU1080 of the first display electrode pair group I based on the timing signal supplied from the timing generating circuit 45. The sustain electrode driving circuit 44b drives the sustain electrodes SU1081 to SU2160 of the second display electrode pair group II based on the timing signal supplied from the timing generating circuit 45.

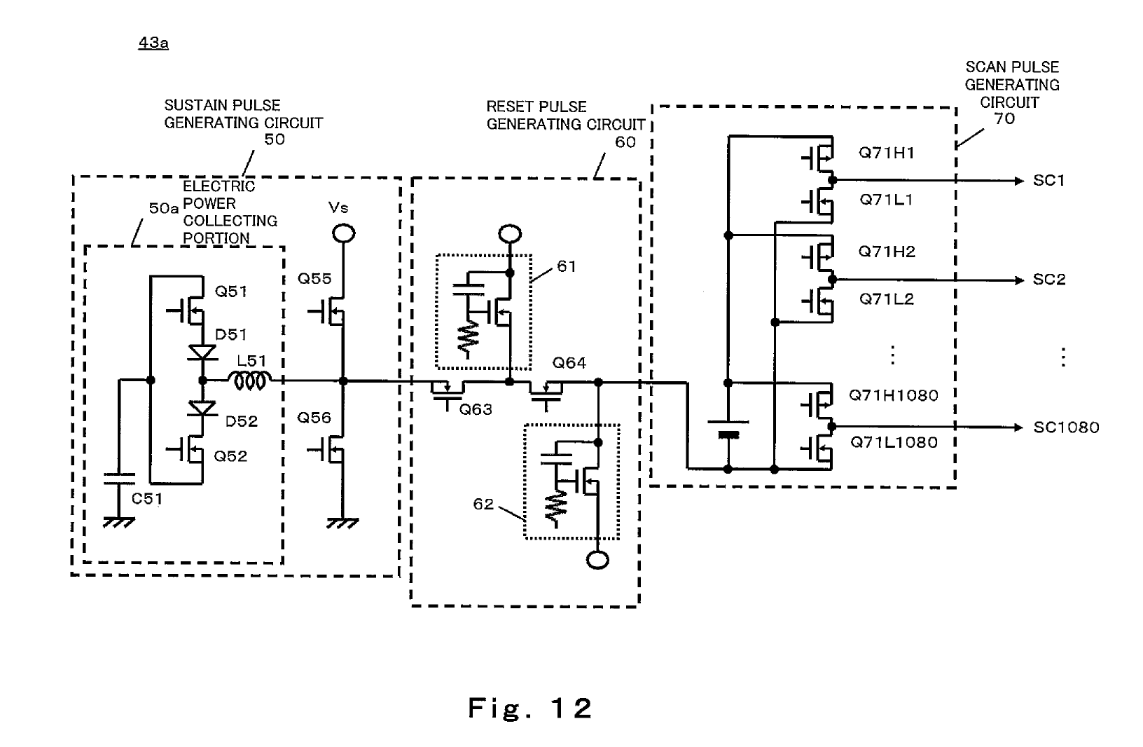

FIG. 12 is a circuit diagram of the scan electrode driving circuit 43a of the plasma display apparatus 100 in Embodiment 1 of the present invention. As shown in FIG. 12, the scan electrode driving circuit 43a of the plasma display apparatus 100 in Embodiment 1 includes a sustain pulse generating circuit 50, a reset pulse generating circuit 60, and a scan pulse generating circuit 70. Since the scan electrode driving circuit 43b is the same in configuration as the scan electrode driving circuit 43a, an explanation thereof is omitted.

The sustain pulse generating circuit 50 is a circuit configured to apply the sustain pulse to the scan electrodes SC1 to SC1080. The sustain pulse generating circuit 50 includes an electric power collecting capacitor C51, switching elements Q51 and Q52, back-flow preventing diodes D51 and D52, and a resonant inductor L51, which constitute an electric power collecting portion 50a. The sustain pulse generating circuit 50 further includes switching elements Q55 and Q56, which constitute a voltage clamping portion.

In the electric power collecting portion 50a, LC resonance of an interelectrode capacity C between the scan electrode 22 and sustain electrode 23 of the display electrode pair 24 and the inductor L51 occurs, thereby causing the rising and falling of the sustain pulse. At the time of the rising of the sustain pulse, the electric charge accumulated in the electric power collecting capacitor C51 is transferred through the switching element Q51, the diode D51, and the inductor L51 to the interelectrode capacity C. At the time of the falling of the sustain pulse, the electric charge accumulated in the interelectrode capacity C is returned through the inductor L51, the diode D52, and the switching element Q52 to the electric power collecting capacitor C51. As above, since the electric power collecting portion 50a can drive the display electrode pairs 24 by the LC resonance without the supply of the electric power from the power supply, the power consumption is ideally zero. The electric power collecting capacitor C51 has an adequately larger capacity than the interelectrode capacity C and is charged to about half (Vs/2) the sustain pulse voltage Vs so as to serve as the power supply of the electric power collecting portion 50a.

The electric power collecting portion 50a does not have to be provided for each display electrode pair group, and the number of electric power collecting portions 50a may be one. However, since the rising and falling of the sustain pulse are carried out by the LC resonance, it is necessary to consider the difference of the interelectrode capacity C of the PDP 10 between the sustain period using the first driving method and the sustain period using the second driving method. Therefore, the timing generating circuit 45 is adjusted such that each of the rising time and falling time of the sustain pulse in the sub-field using the second driving method is longer than those in the sub-field using the first driving method. Specifically, in a case where the number of display electrode pair groups is N, the rising time of the second driving method may be about √N times the rising time of the first driving method. Similarly, the falling time of the second driving method may be about √N times the falling time of the first driving method.

In the voltage clamping portion, the display electrode pair 24 driven through the switching element Q55 is connected to the power supply and clamped to the sustain pulse voltage Vs. Moreover, the display electrode pair 24 driven through the switching element Q56 is connected to ground and clamped to 0 V. Therefore, an impedance at the time of voltage application by the voltage clamping portion is low, and high discharge current by strong sustain discharge can flow stably.

As above, the sustain pulse generating circuit 50 controls the switching elements Q51, Q52, Q55, and Q56 to apply the sustain pulse voltage Vs to the scan electrodes SC1 to SC1080. Each of these switching elements can be constituted by using a generally known element, such as MOSFET or IGBT. In addition, the sustain pulse generating circuit 50 does not have to be divided into two parts for respective display electrode pair groups, and one sustain pulse generating circuit 50 may be provided.

The reset pulse generating circuit 60 includes: a Miller integrator 61 configured to apply the moderately-rising ramp waveform voltage to the scan electrodes SC1 to SC1080 in the reset period; a Miller integrator 62 configured to apply the moderately-falling ramp waveform voltage to the scan electrodes SC1 to SC1080 in the reset period; and switching elements Q63 and Q64. The switching elements Q63 and Q64 are separation switches and provided to prevent the current from flowing backward through parasitic diodes of the switching elements constituting the sustain pulse generating circuit 50 and the reset pulse generating circuit 60.

By such reset pulse generating circuit 60, the ramp waveform voltage toward the positive voltage V2 or the negative voltage V4 can be concurrently applied to the scan electrodes SC1 to SC1080.

The scan pulse generating circuit 70 includes switching elements Q71H1 to Q71H1080 and Q71L1 to Q71L1080 configured to apply the scan pulse voltage Va to the scan electrodes SC1 to SC1080 according to need (for example, the switching elements configured to apply the voltage to the scan electrode SC2 are the elements Q71H2 and Q71L2). The scan pulse generating circuit 70 sequentially applies the scan pulse voltage Va to the scan electrodes SC1 to SC1080 at the above-described timings.

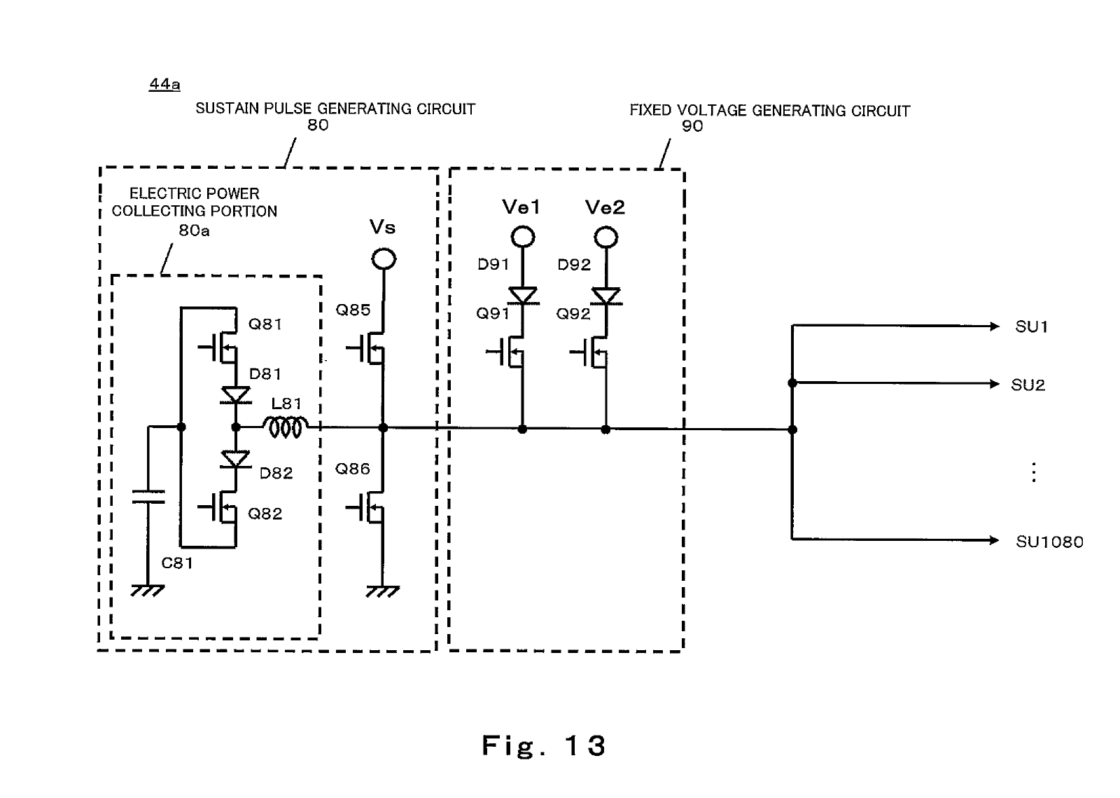

FIG. 13 is a circuit diagram of the sustain electrode driving circuit 44a of the plasma display apparatus 100 according to Embodiment 1 of the present invention. As shown in FIG. 13, the sustain electrode driving circuit 44a of the plasma display apparatus 100 in Embodiment 1 includes a sustain pulse generating circuit 80 and a fixed voltage generating circuit 90. Since the sustain electrode driving circuit 44b is the same in configuration as the sustain electrode driving circuit 44a, an explanation thereof is omitted.

The sustain pulse generating circuit 80 is a circuit configured to apply the sustain pulse to the sustain electrodes SU1 to SU1080. The sustain pulse generating circuit 80 includes an electric power collecting capacitor C81, switching elements Q81 and Q82, back-flow preventing diodes D81 and D82, and a resonant inductor L81, which constitute an electric power collecting portion 80a. The sustain pulse generating circuit 80 further includes switching elements Q85 and Q86, which constitute a voltage clamping portion. Since the sustain pulse generating circuit 80 is the same in configuration as the sustain pulse generating circuit 50, detailed explanations of operations thereof are omitted.

The fixed voltage generating circuit 90 includes switching elements Q91 and Q92 and back-flow preventing diodes D91 and D92. In the fixed voltage generating circuit 90, the positive voltage Ve1 is applied through the switching element Q91 and the back-flow preventing diode D91 to the sustain electrodes SU1 to SU1080 in the reset period. Moreover, the positive voltage Ve2 is applied through the switching element Q92 and the back-flow preventing diode D92 to the sustain electrodes SU1 to SU1080 in the address period.

Embodiment 1 has explained an example in which the PDP 10 is divided into two parts in the vertical direction, and two display electrode pair groups are defined. However, the present invention is not limited to this. It is desirable that the number of display electrode pair groups be determined based on the largest number of sustain pulses applied to the display electrode pair 24 in the sustain period.

### Embodiment 2

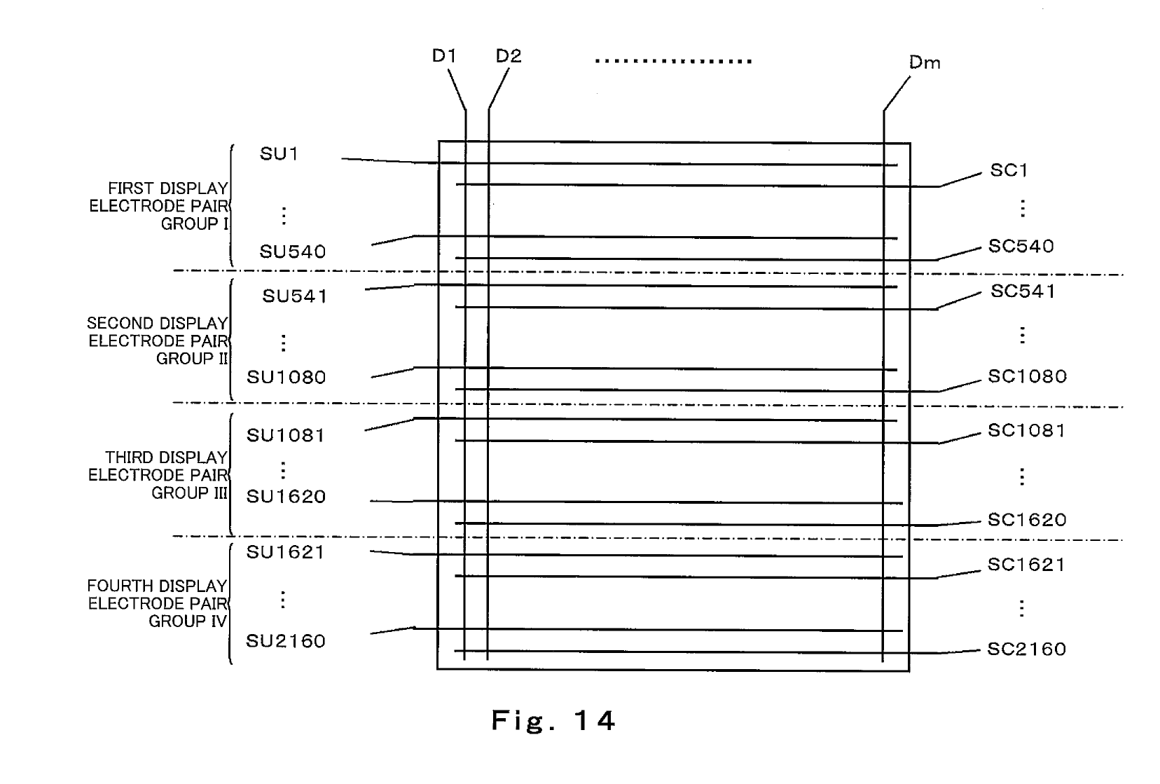

FIG. 14 is a diagram showing the arrangement of electrodes of the PDP 10 in Embodiment 2 of the present invention. In Embodiment 2, the PDP 10 is divided into four parts in the vertical direction, and four display electrode pair groups are defined. That is, a first display electrode pair group I (the scan electrodes SC1 to SC540 and the sustain electrodes SU1 to SU540), a second display electrode pair group II (the scan electrodes SC541 to SC1080 and the sustain electrodes SU541 to SU1080), a third display electrode pair group III (the scan electrodes SC1081 to SC1620 and the sustain electrodes SU1081 to SU1620), a fourth display electrode pair group IV (the scan electrodes SC1621 to SC2160 and the sustain electrodes SU1621 to SU2160) are provided in this order from an upper side of the PDP 10.

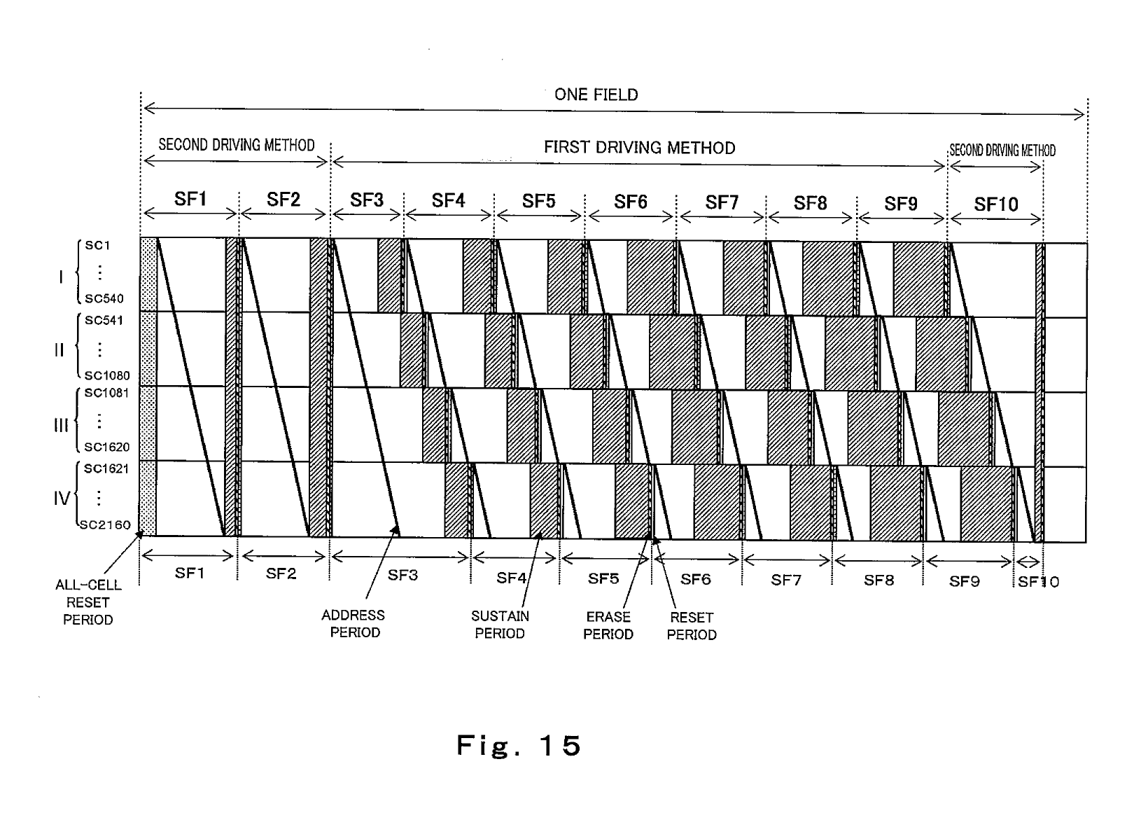

FIG. 15 corresponds to FIG. 14 and is a sub-field configuration diagram of drive voltage waveforms in Embodiment 2 of the present invention. As shown in FIG. 15, by increasing the number of display electrode pair groups, the number of sustain pulses applied to the display electrode pair 24 in the sustain period can be increased, and emitted light luminance of the PDP 10 can be increased.

Moreover, in the driving method of Embodiment 2, the erase period and the reset period are provided immediately before the address period of the next sub-field. Moreover, in the sub-fields in which the first driving method is selected, in periods other than the reset period and the erase period, the address operation is consecutively carried out in any one of a plurality of display electrode pair groups. In addition, a period in which discharge does not occur is provided between the address period and the sustain period such that the sustain period terminates immediately before the erase period. Further, in the driving method of Embodiment 2, the sustain operation is carried out in any one of a plurality of display electrode pair groups in the erase period or the reset period or in both the erase period and reset period in the sub-field in which the first driving method is selected. In accordance with this method, the erase discharge can be carried out using priming generated by the sustain discharge, and an erase operation can be stably carried out.

### Embodiment 3

In Embodiments 1 and 2, the driving method selecting circuit 46 is included, which is configured to select the first driving method or the second driving method as the driving method of the PDP 10. However, in Embodiment 3 of the present invention, the driving method selecting circuit 46 is not included. Instead of the driving method selecting circuit 46, the image signal processing circuit 41 includes a LUT (look-up table). This LUT prestores information regarding whether each sub-field uses the first driving method or the second driving method. To be specific, a control circuit according to the present invention is realized by the image signal processing circuit 41 and the timing generating circuit 45. Whether to select the first driving method or the second driving method as the driving method of the PDP 10 is determined in accordance with the same standards as in Embodiments 1 and 2. Moreover, in Embodiment 3, one field period includes both the sub-field driven by the first driving method and the sub-field driven by the second driving method. As compared to Embodiments 1 and 2, drive control of the PDP 10 and configurations of peripheral circuits of the PDP 10 are simplified in Embodiment 3.

### Embodiment 4

Embodiment 4 of the present invention will explain a case where the sustain period of each sub-field is set in a specific range.

Specifically, in Embodiment 4,in a case where the number of display electrode pair groups is N, and a time required for carrying out the address operation once in all the discharge cells is Tw, the sustain periods of the sub-fields of each display electrode pair group are set within a range of Tw×(N−1)/N or less in accordance with the luminance weights of the sub-fields. In other words, in Embodiment 4, the sustain periods are set such that an inequality “Ts (time assigned for the sustain period of the sub-field in which the luminance weight is the highest)≦Tw×(N−1)/N” is satisfied.

The above “Tw” indicates a time required for carrying out the address operation once in all the discharge cells by the single scan method in which the addressing is sequentially carried out with respect to a plurality of display electrode pairs existing in the entire panel. In this single scan method, the address periods with respect to respective display electrode pair groups do not overlap one another. That is, the addressing with respect to two or more display electrode pair groups at the same time does not occur.

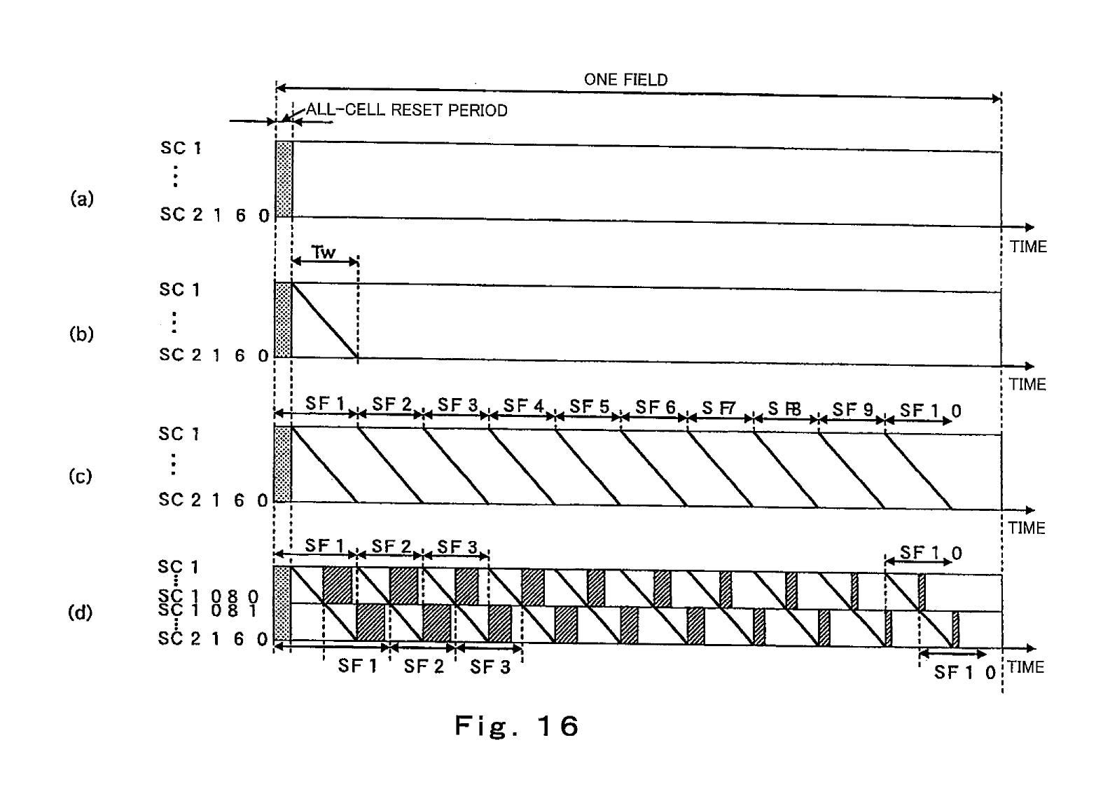

FIG. 16 is a diagram for explaining the driving method and a method for setting the number of display electrode pair groups in Embodiment 4 and is a diagram schematically showing drive voltage waveforms applied to the scan electrodes SC1 to SC2160 of the PDP 10 in one field period.

In FIGS. 16 (a) to 16 (d), a vertical axis denotes the scan electrodes SC1 to SC2160, and a horizontal axis denotes a time. In addition, a timing for carrying out the address operation is shown by a solid line, and timings for the sustain period and the wall voltage adjusting period are shown by hatching.

As is clear from FIGS. 16(a) to 16(d), in Embodiment 4, the sustain period and the number of display electrode pair groups are set on the assumption that the PDP 10 is driven by the first driving method. Then, as described in Embodiments 1 to 3, the first driving method or the second driving method is selected (determined in Embodiment 3) under such set conditions based on the result of the comparison between the length of the sustain period and the length of the wall voltage adjusting period.

Specifically, in a case where one field period is 16.7 ms and a time required for carrying out the address operation for one scan electrode is 0.7 μs, a time Tw necessary for carrying out the address operation once for all of 2,160 scan electrodes is 1,512 μs (about 1.5 ms (=0.7×2,160)). Moreover, the number N of display electrode pair groups is set to two, the display electrode pairs located at an upper half of the PDP 10 are set as the first display electrode pair group I, and the display electrode pairs located at a lower half of the PDP 10 are set as the second display electrode pair group II. To be specific, 1,080 scan electrodes SC1 to SC1080 and 1,080 sustain electrodes SU1 to SU1080 belong to the first display electrode pair group I, and 1,080 scan electrodes SC1081 to SC2160 and 1,080 sustain electrodes SU1081 to SU2160 belong to the second display electrode pair group II.

First, as shown in FIG. 16(a), the all-cell reset period in which the reset discharge concurrently occurs in the discharge cells of the entire PDP 10 is provided at the beginning of one field period. Herein, a time required for the all-cell reset period is set to 500 μs.

Next, as shown in FIG. 16(b), the time Tw necessary for sequentially applying the scan pulse to the scan electrodes SC1 to SC2160 is estimated. At this time, in order to consecutively carry out the address operation, it is preferable that the scan pulse be as short as possible and be applied as consecutively as possible.

Next, the number of sub-fields in one field is estimated. Herein, since a time required for the wall voltage adjusting period is short, it is ignored. The all-cell reset period (0.5 ms) is subtracted from one field period (16.7 ms), and the obtained value is divided by the time (1.5 ms) necessary for carrying out the address operation once in all scan electrodes ((16.7−0.5)/1.5=10.8). The obtained value (10.8) corresponds to the number of sub-fields set in one field. Therefore, as shown in FIG. 16(c), 10 sub-fields (SF1, SF2, . . . , SF10) can be set in one field at most.

Next, as shown in FIG. 16(d), the sustain period in which the sustain pulse is applied is provided after the addressing of the scan electrodes of two display electrode pair groups. For example, the sustain pulses of “60”, “44”, “30”, “18”, “11”, “6”, “3”, “2”, “1”, and “1” are respectively applied in 10 sub-fields.

In a case where the sustain pulse width (cycle) is 10 μs, a time assigned to the sustain period of the sub-field in which the luminance weight is “60” that is the highest is 600 μs. In this case, since N=2, Tw=1,512 μs, and Ts=600 μs, Tw×(N−1)/N=756≧600, and the above “Tw×(N×1)/N≧Ts” is satisfied.

As above, for example, the number N of display electrode pair groups of the PDP 10 and the time of the sub-field in each display electrode pair group can be set.

In accordance with the above driving method, the sustain period of each sub-field in each display electrode pair group is set within a range of Tw×(N−1)/N or less in accordance with the luminance weight of the sub-field. Therefore, the scan pulse and the address pulse can be arranged such that the address operation is consecutively carried out in either one of the display electrode pair groups after the all-cell reset period. As a result, 10 sub-fields can be set in one field period, that is, a maximum number of sub-fields can be set in one field period.

In the PDP in which the number of lines is small, the time Tw necessary for carrying out the address operation once in all the scan electrodes is short. Therefore, the sustain period which can be set in a range of Tw×(N−1)/N or less in each sub-field is also short. However, in the high-definition PDP in which the number of lines is 1,080 or more, the time Tw necessary for carrying out the address operation once in all the scan electrodes is long, the time of Tw×(N−1)/N is long, and a maximum time Ts of the sustain period which can be assigned to each sub-field is also long. Therefore, the driving method of the present embodiment is especially useful in the case of driving the high-definition PDP.

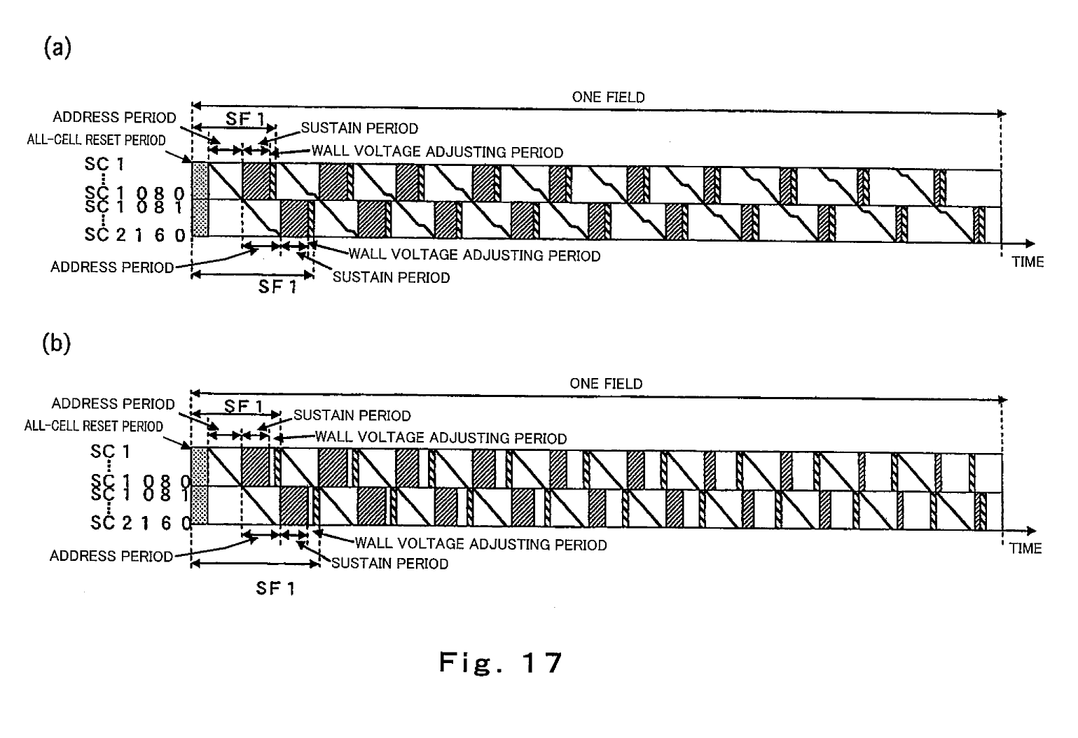

FIG. 17 is a schematic sub-field configuration diagram of drive voltage waveforms. In FIG. 17, a vertical axis denotes the scan electrodes SC1 to SC2160, and a horizontal axis denotes a time. In addition, a timing for carrying out the address operation is shown by a solid line, and timings for the sustain period and the wall voltage adjusting period are shown by hatching.

FIG. 17(a) shows the drive voltage waveforms in a case where the wall voltage adjusting period is provided immediately after the sustain period. The address operation of the second display electrode pair group II is restricted when the first display electrode pair group I is in the wall voltage adjusting period, and the address operation of the first display electrode pair group is restricted when the second display electrode pair group II is in the wall voltage adjusting period.

FIG. 17(b) shows the drive voltage waveforms in a case where provided immediately before the address period is the wall voltage adjusting period of the previous sub-field. The address operation of the second display electrode pair group II is restricted when the first display electrode pair group I is in the wall voltage adjusting period, and the address operation of the first display electrode pair group I is restricted when the second display electrode pair group II is in the wall voltage adjusting period.

As above, in a case where the address operation is restricted when either one of the display electrode pair groups is in the wall voltage adjusting period, the sub-field configuration and the number N of display electrode pair groups are set in consideration of the time required for the wall voltage adjusting period.

Moreover, it is preferable that the all-cell reset period in which the reset discharge occurs in each discharge cell be provided at the beginning of one field and the wall voltage adjusting period in which the wall voltage is adjusted be provided after the sustain period of each sub-field of each display electrode pair group. Thus, as compared to a case where the all-cell reset period is provided for each sub-field, the all-cell reset period in one field can be shortened, and this contributes to the increase in the number of sub-fields in one field.

Moreover, it is preferable that in the all-cell reset period, the reset pulse be concurrently applied to respective scan electrodes constituting a plurality of display electrode pairs. Thus, the wall voltage of each discharge cell can be adequately adjusted in the wall voltage adjusting period provided between the sustain period and the address period without providing the all-cell reset period for each sub-field.

Moreover, it is preferable that the sub-field in which the luminance weight is the lowest be provided as the last one of a plurality of sub-fields in one field period. Since the time length of the last sub-field can be shortened, this contributes to the increase in the number of sub-fields set in one field.

Respective numerical values used in Embodiments 1 to 4 are just examples, and it is desirable that those numerical values be suitably set to most appropriate values in accordance with the characteristics of the PDP 10, the spec of the plasma display apparatus 100, and the like.

Moreover, each of Embodiments 1 to 4 has explained an example which uses the single scan method in which the addressing is sequentially carried out with respect to 2,160 lines. However, for example, the driving method explained in the above embodiments can be applied to two divided regions of a known dual drive PDP including 4,320 lines. Thus, the ultra high-definition PDP including 4,320 lines can be realized. In this case, although a driving circuit is required for each region, the ultra high-definition PDP can be realized comparatively easily.

Moreover, needless to say, the driving method explained in Embodiments 1 to 4 may not be applied to all fields but may be applied to a part of the fields.

Moreover, needless to say, in Embodiments 1 and 2, selecting the first driving method or the second driving method as the driving method of the PDP 10 may be carried out only in a part of the sub-fields.

From the foregoing explanation, many modifications and other embodiments of the present invention are obvious to one skilled in the art. Therefore, the foregoing explanation should be interpreted only as an example and is provided for the purpose of teaching the best mode for carrying out the present invention to one skilled in the art. The structures and/or functional details may be substantially modified within the spirit of the present invention.

### INDUSTRIAL APPLICABILITY

In accordance with the plasma display panel driving method and plasma display apparatus according to the present invention, even in the case of the ultra-large ultra-high-definition plasma display panel including 2,160 lines or more, the number of sub-fields can be adequately secured for securing the image quality, and the plasma display panel can be driven by adequate luminance. Therefore, the present invention is useful to drive the high-definition plasma display apparatus by high luminance.

### REFERENCE SIGNS LIST

10 PDP

21 front substrate

22 scan electrode

22a, 23a transparent electrode

22b, 23b bus electrode

23 sustain electrode

24 display electrode pair

25, 33 dielectric layer

26 protective layer

31 rear substrate

32 data electrode

34 dividing wall

35 phosphor layer

41 image signal processing circuit

42 data electrode driving circuit

43a, 43b scan electrode driving circuit

44a, 44b sustain electrode driving circuit

45 timing generating circuit

46 driving method selecting circuit

50, 80 sustain pulse generating circuit

50a, 80a electric power collecting portion

60 reset pulse generating circuit

61, 62 Miller integrator

70 scan pulse generating circuit

90 fixed voltage generating circuit

100 plasma display apparatus

1. A method for driving a plasma display panel including: a first substrate on which a plurality of display electrode pairs are arranged side by side, each of the plurality of display electrode pairs being constituted by a scan electrode and a sustain electrode; and a second substrate which is provided to be opposed to the first substrate and on which a plurality of data electrodes are arranged so as to three-dimensionally cross the plurality of display electrode pairs, discharge cells being configured at respective positions where the plurality of display electrode pairs and the plurality of data electrodes three-dimensionally cross one another,
the method comprising the steps of:
dividing the plurality of display electrode pairs into N (N is an integer of 2 or more) display electrode pair groups;
dividing one field into M (M is an integer of 2 or more) sub-fields SFL (L=1 to M), each of the sub-fields including a wall voltage adjusting period in which a wall voltage of the discharge cell is adjusted for address discharge of the discharge cell, an address period in which the address discharge of the discharge cell selected in accordance with an image signal is carried out, and a sustain period in which sustain discharge of the discharge cell in which the address discharge has been carried out is carried out; and
in a case where the sustain period of a K-th sub-field SFK is defined as T1 and the wall voltage adjusting period positioned between the sustain period T1 and the address period of a (K+1)-th sub-field is defined as T2,
if T1>(N−1)×T2, using a first driving method in the sub-field SFK, the first driving method being a method for setting the sustain period and the wall voltage adjusting period in the sub-field SFK for each of the N display electrode pair groups, and
if T1<(N−1)×T2, using a second driving method in the sub-field SFK, the second driving method being a method for setting the sustain periods and the wall voltage adjusting periods in the sub-field SFK such that the sustain periods are synchronized with one another and the wall voltage adjusting periods are synchronized with one another among the N display electrode pair groups, wherein:
one or more all-cell reset periods in each of which reset discharge is concurrently carried out in all the discharge cells are included in one field period; and
the sub-field provided immediately after the all-cell reset period is a sub-field whose luminance weight is lowest among the M sub-fields SFL (L=1 to M) of one field period, and the sub-field provided immediately before the all-cell reset period is a sub-field whose luminance weight is not highest among the M sub-fields SFL (L=1 to M) of one field period.

2. (canceled)

3. (canceled)

4. (canceled)

5. (canceled)

6. (canceled)

7. (canceled)

8. (canceled)

9. (canceled)

10. (canceled)

11. (canceled)

12. The method according to claim 1, wherein the sub-field provided immediately before the all-cell reset period is a sub-field whose luminance weight is second lowest among the M sub-fields SFL (L=1 to M) of one field period.

13. A method for driving a plasma display panel including: a first substrate on which a plurality of display electrode pairs are arranged side by side, each of the plurality of display electrode pairs being constituted by a scan electrode and a sustain electrode; and a second substrate which is provided to be opposed to the first substrate and on which a plurality of data electrodes are arranged so as to three-dimensionally cross the plurality of display electrode pairs, discharge cells being configured at respective positions where the plurality of display electrode pairs and the plurality of data electrodes three-dimensionally cross one another,
the method comprising the steps of:
dividing the plurality of display electrode pairs into N (N is an integer of 2 or more) display electrode pair groups;
dividing one field into M (M is an integer of 2 or more) sub-fields SFL (L=1 to M), each of the sub-fields including a wall voltage adjusting period in which a wall voltage of the discharge cell is adjusted for address discharge of the discharge cell, an address period in which the address discharge of the discharge cell selected in accordance with an image signal is carried out, and a sustain period in which sustain discharge of the discharge cell in which the address discharge has been carried out is carried out; and
in a case where the sustain period of a K-th sub-field SFK is defined as T1 and the wall voltage adjusting period positioned between the sustain period T1 and the address period of a (K+1)-th sub-field is defined as T2,
if T1>(N−1)×T2, using a first driving method in the sub-field SFK, the first driving method being a method for setting the sustain period and the wall voltage adjusting period in the sub-field SFK for each of the N display electrode pair groups, and
if T1<(N−1)×T2, using a second driving method in the sub-field SFK, the second driving method being a method for setting the sustain periods and the wall voltage adjusting periods in the sub-field SFK such that the sustain periods are synchronized with one another and the wall voltage adjusting periods are synchronized with one another among the N display electrode pair groups, wherein
each of a rising time and falling time of a sustain pulse which causes the sustain discharge in the sustain period is shorter in the sub-field in which the first driving method is selected than in the sub-field in which the second driving method is selected.

14. (canceled)

15. (canceled)

16. (canceled)

17. (canceled)

18. (canceled)

19. (canceled)

20. (canceled)

21. (canceled)

22. (canceled)

23. (canceled)

24. A plasma display apparatus comprising:
a plasma display panel including a first substrate on which a plurality of display electrode pairs are arranged side by side, each of the plurality of display electrode pairs being constituted by a scan electrode and a sustain electrode, and a second substrate which is provided to be opposed to the first substrate and on which a plurality of data electrodes are arranged so as to three-dimensionally cross the plurality of display electrode pairs, discharge cells being configured at respective positions where the plurality of display electrode pairs and the plurality of data electrodes three-dimensionally cross one another;
N scan electrode driving circuits configured to respectively drive the scan electrodes of N display electrode pair groups obtained by dividing the plurality of display electrode pairs into N (N is an integer of 2 or more) groups;
N sustain electrode driving circuits configured to respectively drive the sustain electrodes of the N display electrode pair groups;
a data electrode driving circuit configured to drive the plurality of data electrodes; and
a control circuit configured to control the N scan electrode driving circuits, the N sustain electrode driving circuits, and the data electrode driving circuit such that
in a case where one field is divided into M (M is an integer of 2 or more) sub-fields SFL (L=1 to M) each including a wall voltage adjusting period in which a wall voltage of the discharge cell is adjusted for address discharge of the discharge cell, an address period in which the address discharge of the discharge cell selected in accordance with an image signal is carried out, and a sustain period in which sustain discharge of the discharge cell in which the address discharge has been carried out is carried out, the sustain period of a K-th sub-field SFK is defined as T1, and the wall voltage adjusting period positioned between the sustain period T1 and the address period of a (K+1)-th sub-field is defined as T2,
if T1>(N−1)×T2, a first driving method is used in the sub-field SFK, the first driving method being a method for setting the sustain period and the wall voltage adjusting period in the sub-field SFK for each of the N display electrode pair groups, and
if T1<(N−1)×T2, a second driving method is used in the sub-field SFK, the second driving method being a method for setting the sustain periods and the wall voltage adjusting periods in the sub-field SFK such that the sustain periods are synchronized with one another and the wall voltage adjusting periods are synchronized with one another among the N display electrode pair groups, wherein
the control circuit controls such that each of a rising time and falling time of a sustain pulse which causes the sustain discharge in the sustain period is shorter in the sub-field using the first driving method than in the sub-field using the second driving method.

25. (canceled)

26. (canceled)

27. (canceled)

28. (canceled)

29. (canceled)

30. The method according to claim 1, wherein the sub-field provided two periods before the all-cell reset period is a sub-field whose luminance weight is highest among the M sub-fields SFL (L=1 to M) of one field period.

31. A method for driving a plasma display panel including: a first substrate on which a plurality of display electrode pairs are arranged side by side, each of the plurality of display electrode pairs being constituted by a scan electrode and a sustain electrode; and a second substrate which is provided to be opposed to the first substrate and on which a plurality of data electrodes are arranged so as to three-dimensionally cross the plurality of display electrode pairs, discharge cells being configured at respective positions where the plurality of display electrode pairs and the plurality of data electrodes three-dimensionally cross one another,
the method comprising the steps of:
dividing the plurality of display electrode pairs into N (N is an integer of 2 or more) display electrode pair groups;
dividing one field into M (M is an integer of 2 or more) sub-fields SFL (L=1 to M), each of the sub-fields including a wall voltage adjusting period in which a wall voltage of the discharge cell is adjusted for address discharge of the discharge cell, an address period in which the address discharge of the discharge cell selected in accordance with an image signal is carried out, and a sustain period in which sustain discharge of the discharge cell in which the address discharge has been carried out is carried out; and
in a case where the sustain period of a K-th sub-field SFK is defined as T1 and the wall voltage adjusting period positioned between the sustain period T1 and the address period of a (K+1)-th sub-field is defined as T2,
if T1>(N−1)×T2, using a first driving method in the sub-field SFK, the first driving method being a method for setting the sustain period and the wall voltage adjusting period in the sub-field SFK for each of the N display electrode pair groups, and
if T1<(N−1)×T2, using a second driving method in the sub-field SFK, the second driving method being a method for setting the sustain periods and the wall voltage adjusting periods in the sub-field SFK such that the sustain periods are synchronized with one another and the wall voltage adjusting periods are synchronized with one another among the N display electrode pair groups, wherein:
one or more all-cell reset periods in each of which reset discharge is concurrently carried out in all the discharge cells are included in one field period;
the sub-field provided immediately before the all-cell reset period is a sub-field whose luminance weight is lowest among the M sub-fields SFL (L=1 to M) of one field period, and the sub-field provided immediately after the all-cell reset period is a sub-field whose luminance weight is second lowest among the M sub-fields SFL (L=1 to M) of one field period; and
in a case where light is emitted in the sub-field other than the sub-field whose luminance weight is lowest among the M sub-fields SFL (L=1 to M) of one field period , light is emitted in the sub-field whose luminance weight is second lowest among the M sub-fields SFL (L=1 to M) of one field period.
